(19) United States
(12) Patent Application Publication
(10) Pub. No.: US 2026/0295883 A1
(43) Pub. Date: Oct. 1, 2026

(54) CUTTING TOOL

(71) Applicant: Rennsteig Werkzeuge GmbH, Steinbach-Hallenberg (DE)

(72) Inventors: Georg HOLLAND-MORITZ, Steinbach-Hallenberg (DE); Benjamin WEISHEIT, Floh-Seligenthal (DE)

(73) Assignee: Rennsteig Werkzeuge GmbH, Steinbach-Hallenberg (DE)

(21) Appl. No.: 19/477,957

(22) PCT Filed: Apr. 23, 2024
(86) PCT No.: PCT/EP2024/061091

§ 371 Date: Oct. 23, 2025

(30) Foreign Application Priority Data
Apr. 26, 2023 (DE) 10 2023 110 695.3
Sep. 7, 2023 (DE) 10 2023 124 156.7

(51) Int. Cl. B26D 3/16

(52) U.S. Cl. CPC B26D 3/169

(57) ABSTRACT

A cutting tool has two cutting parts, the cutting parts being connected to each other in a joint for respective movement along a cutting plane, the cutting parts, in an open state of the cutting parts, further delimiting a cutting mouth, and each having free ends facing away from the joint and ends facing the joint. An angular receiving part is hinged to the free end of one of the cutting parts, which receiving part can be pivoted between a swung-out receiving position and a swung-in holding position for holding a workpiece during a cutting operation.

### CROSS REFERENCE TO RELATED APPLICATIONS

This application is the National Stage of PCT/EP2024/061091 filed on Apr. 23, 2024, which claims priority under 35 U.S.C. § 119 of German Application No. 10 2023 110 695.3 filed on Apr. 26, 2023 and German Application No. 10 2023 124 156.7 filed Sep. 7, 2023, the disclosures of which are incorporated by reference. The international application under PCT article 21(2) was not published in English.

### TECHNICAL FIELD

The invention relates to a cutting tool, having a first cutting part and a second cutting part, the cutting parts being connected to one another by a joint for respective movement along a cutting plane, the cutting parts further bounding, in an open state of the cutting parts, a cutting mouth, and each having free ends remote from the joint and ends facing the joint.

### PRIOR ART

Cutting tools of the type in question are known in various embodiments, for example for cutting electrical cables, in particular ground cables, or pipes, in particular plastic pipes. The cutting parts that bound the cutting mouth of the cutting tool may each be fashioned knife-like. Embodiments are also known in which only one cutting part, in particular a movable cutting part, is fashioned knife-like. The other cutting part may in this case merely support the workpiece to be cut in the region of the cutting mouth.

From U.S. Pat. No. 6,370,780 B1 a cutting tool is known in which the first cutting part is formed with a receiving surface for holding the workpiece to be cut and with an insertion slot passing through the receiving surface for the second cutting part. Reference may also be made to U.S. Pat. No. 4,312,127 A, which discloses a second cutting part mounted on the first cutting part and actuatable via a ratchet drive. The same is also known, for example, from U.S. Pat. No. 6,098,291 A.

U.S. Pat. No. 4,905,350 discloses pliers for opening shells, in which one plier leg is formed with a wedge-shaped working surface and the other plier leg provides, as the working surface, a support for a shell to be opened. A seating element is articulated to the support and can be pivoted in for opening smaller shells in order to obtain a support closer to the wedge formation.

US 2014/0020528 A1 discloses a cutting tool with pivoting jaws, in which a locking mechanism is provided to prevent a cutting part from bending out during a cutting operation.

U.S. Pat. No. 6,640,441 B1 discloses a cutting tool in which support parts provided on both sides of one of the cutting parts are each connected to a seating part that is movable by a few degrees relative to the respective support part, for securely holding a part to be cut, for example a tubular part.

JP 2009-219679 A discloses a cutting tool in which a U-shaped receiving part is pivotable between a swung-out receiving position and a swung-in holding position. The articulation is provided at the transition from a U-web to a U-leg that is lower during performance of the cutting operation. Apart from its pivotability, the receiving part is mounted immovably on the respective cutting part.

US 2022/0287511 A1 discloses kitchen shears having a band-shaped receiving part. The band-shaped receiving part is displaceable to define a larger or smaller receiving space.

JP 60-195675 U discloses a cutting tool in which a support part that forms an extension of a receiving contour of a cutting part is arranged displaceably on the cutting part.

Starting from prior art as exemplified by U.S. Pat. No. 4,905,350 A, the object is to provide an advantageous cutting tool.

### SUMMARY OF THE INVENTION

This object is achieved, first, by a cutting tool cutting tool having two cutting parts, the cutting parts being connected to each other in a joint for respective movement along a cutting plane, the cutting parts, in an open state of the cutting parts, further delimiting a cutting mouth, and each having free ends facing away from the joint and ends facing the joint. during a cutting operation, wherein an angular receiving part is articulated at the free end of one of the cutting parts, the receiving part being pivotable between a swung-out receiving position and a swung-in holding position for holding a workpiece to be cut during a cutting operation, wherein the receiving opening in a swung-out receiving position is oriented essentially in the same direction as the cutting-receiving opening of the cutting mouth, such that a workpiece to be introduced into the receiving part passes through both the cutting-receiving opening and the receiving opening, or that the receiving part, in the region of the resulting receiving contour, has an essentially L-shaped configuration with a first U-leg forming an insertion leg and a U-web forming a support leg, and that the articulation of the receiving part to the stationary cutting part is provided in the region of a transition between the first U-leg and the U-web.

The object is further achieved by a cutting tool, wherein it is provided that the receiving part has two insertion legs, a first and a second insertion leg, which together with a support leg provide a U-shaped configuration of the receiving part, and that the first insertion leg is displaceable along the support leg to change the size of a receiving-part opening area.

This object is also achieved by a cutting tool, wherein it is provided that the receiving part has a U-shaped configuration or an L-shaped configuration with a U-leg forming an insertion leg and a U-web forming a support leg, and that the insertion leg is displaceable along the support leg.

Owing to the arrangement of the angular receiving part, insertion of the workpiece-particularly workpieces of comparatively large diameter-into the cutting mouth is made easier in terms of handling. The workpiece is preferably placed into the receiving part swung out into the receiving position or brought into a forward position relative to the assigned cutting part, and is then brought together with the receiving part, by swinging in or by sliding the receiving part back, into the holding position in which the cutting operation can then take place. For this purpose the receiving part is arranged at a free end of a cutting part that bounds the cutting mouth, preferably articulated or mounted so as to be slidable.

In an embodiment in which pivotability of the receiving part is provided, the geometric pivot axis of the receiving part may be aligned with a geometric pivot axis of the cutting parts. Accordingly, in a preferred embodiment, the geometric pivot axis of the receiving part extends essentially perpendicular to the cutting plane.

If the receiving part is displaceable, a rectilinear direction of displacement may be provided which extends essentially along a longitudinal extent of the assigned cutting part.

The receiving part has a first receiving leg and a second receiving-part leg extending at an acute or obtuse angle thereto. With regard to the preferred U-shaped configuration of the receiving part described below, the receiving-part leg corresponds to the U-web and the other leg, the receiving leg, corresponds to one of the U-legs, which is also referred to as the insertion leg.

In a pivotable arrangement on the cutting part, the receiving part can be displaced from the receiving position toward the holding position, and back from the holding position to the receiving position, over a pivot angle of more than 30°, more preferably 45° up to, for example, 90°, in particular about 55° to 60°. The end positions, i.e. the receiving position and/or the holding position, may be limited by stops.

In the receiving position, the receiving part may extend at least in sections outside the cutting mouth bounded by the cutting parts. The workpiece to be cut is therefore preferably received substantially outside the cutting mouth by the receiving part and guided into the region of the cutting mouth by swinging-in or pushing back into the holding position.

The swinging or sliding displacement of the receiving part from the receiving position into the holding position may be carried out manually, e.g. by directly acting on the receiving part, or alternatively by acting on the workpiece inserted into the receiving part. In electrically or electro-hydraulically driven cutting tools, the respective drive energy can also be used, if appropriate, to motor-displace the receiving part.

The cutting parts do not each need to be formed with a cutting edge. One of the cutting parts, preferably the first cutting part, may merely act as a counter-support. The counter-support may be formed as an anvil with a bearing surface extending transversely to the cutting plane. The counter-support may also be formed with an insertion opening, possibly as an insertion slot, for a cutting edge of the other, second cutting part.

In a possible embodiment, the receiving part is pivotably or slidably mounted at the free end of the cutting part designed as a counter-support.

To adapt the receiving space to the cross-sectional extent of the workpiece to be cut, for example its diameter, a detent adjustment may be provided, which may also be of independent significance alone and irrespective of the further configuration of the cutting tool, in particular with regard to the pivotable or slidable arrangement of the receiving part at the free end of the cutting part.

For example, the insertion leg may be displaceable relative to the support leg and/or the assigned cutting part, and/or the support leg may be displaceable relative to the insertion leg and/or the cutting part, wherein the desired displacement position may be secured by a detent at least during the cutting operation.

Such a detent may already be present in the swung-out or advanced receiving position of the receiving part and may be maintained in the swung-in or retracted holding position at least until completion of the cutting operation. Alternatively, the detent may also first be effected in the holding position or during the pivoting or sliding displacement of the receiving part into the holding position.

The detent position may, as further preferred, be releasable only by a deliberate user action, for example during or as a result of a displacement of the receiving part back in the direction of the receiving position. A targeted release of the detent may also be carried out prior to initiating the return displacement of the receiving part.

Further features are explained below, also in the description of the figures, often in their preferred association with the generally described solution or with further features. However, they may also be of significance only in association with individual features already described or with the respective further described feature, or in each case independently.

Thus, in a preferred embodiment, the cutting tool may be hand-operated and have a first and a second handle part. One of the handle parts may in this case be designed as a stationary handle part and the other handle part as a handle part pivotable relative to the stationary handle part.

Furthermore, the first cutting part may be designed as a stationary cutting part, with the joint connecting the two cutting parts to one another arranged on the first cutting part. In the case of a hand-operated cutting tool, the stationary handle part may also be rigidly connected to the stationary cutting part.

In a further preferred embodiment, both handle parts are mounted on the stationary cutting part, more preferably the stationary handle part in rigid connection with the stationary cutting part and the pivotable handle part via an additional joint arrangement if appropriate. Furthermore, and as also preferred, the second cutting part may be pivotable via a ratchet drive. For this purpose, in particular, the pivotable handle part may act, when operated, via a feed lever on a toothing formed on the second cutting part and thereby bring about a pivot displacement of the second cutting part, while preferably a pawl lever likewise engaging in the toothing prevents an undesired return displacement of the second cutting part.

According to a preferred embodiment, the receiving part is articulated at the free end of the stationary cutting part. Accordingly, during a cutting operation, the second cutting part also moves relative to the receiving part accommodating the workpiece to be cut.

The cutting parts of the cutting tool are preferably arranged so that they can be moved past one another in a scissor-like manner. In this case, in particular the first, stationary cutting part may serve directly, but preferably only indirectly via the receiving part, as an abutment for the workpiece to be cut, while the second, pivotable cutting part has a cutting edge with a blade-like cutting configuration.

The second, pivotable cutting part may, with reference to the cutting plane, be movable along the side of the first, stationary cutting part during and in particular toward the end of the cutting operation. In this context, a configuration is further preferred in which the first cutting part has a first insertion slot into which the second cutting part enters during a cutting operation. In this way, an advantageous support of the workpiece to be cut is obtained on both sides of the cutting plane, directly or indirectly, against the first, stationary cutting part.

In order also to achieve favorable support of the workpiece to be cut in the region of the receiving part during the cutting operation, the receiving part in a preferred embodiment likewise has a second insertion slot into which the second cutting part can enter during a cutting operation. The first insertion slot of the first cutting part and the second insertion slot of the receiving part extend together in correspondence with the cutting plane.

Viewed perpendicularly to the cutting plane, the second insertion slot is preferably larger than the first insertion slot. In the holding position, the first insertion slot is more preferably arranged within the second insertion slot.

Viewed perpendicularly to the cutting plane, i.e. in the direction of the geometric pivot axis of the second cutting part, the receiving part may have a substantially U-shaped configuration. The receiving part may have two U-legs, optionally substantially parallel to one another, and a U-web connecting these U-legs. The U-legs may also diverge toward the U-opening by a small angle of, for example, 1° to 10°, more specifically about 5°.

The receiving part has a receiving contour which bounds an opening area of the U-shaped configuration. Furthermore, the opening area is in particular bounded by the inner, substantially mutually facing abutment surfaces of the U-legs and of the U-web, as well as by an opening plane touching the free ends of the U-legs of the receiving part and extending along the opening formed between the U-legs. In a preferred embodiment, this receiving contour is not penetrated by an outermost edge of the first cutting part, irrespective of the pivot position of the receiving part. Thus, in no displacement position of the receiving part, including intermediate positions, does any portion of the cutting part project into the opening area of the receiving-part configuration.

The receiving part may have an insertion leg and a support leg extending approximately at right angles thereto. In the case of the U-shaped configuration of the receiving part, the insertion leg is one of the U-legs, while the support leg is essentially formed by the U-web. In the basic configuration described initially, it is also possible that only the insertion leg and the support leg are provided. The insertion leg may furthermore enclose an acute angle of, for example, more than 60° up to an obtuse angle of, for example, about 120°, more preferably more than 70° up to less than 90°, and for example about 80°.

In the swung-in or retracted state of the receiving part, which state corresponds to the holding position, the insertion leg may substantially close the cutting mouth before and also during a cutting operation. In this case, the insertion leg may extend substantially transversely to the first, stationary cutting part in the direction of the opposite second cutting part, at least with reference to a tool position before commencement of the cutting operation. In this situation, a gap may be present between the free end of the insertion leg and the adjacent second cutting part and/or a fixed section of the cutting tool assigned to the second cutting part; however, in a preferred embodiment this gap is smaller than the diameter or the minimum cross-sectional dimension of a workpiece to be received in the cutting mouth.

In a further embodiment, the receiving part may have two insertion legs, a first and a second insertion leg, which together with the support leg provide the U-shaped configuration of the receiving part. The two insertion legs extending from the support leg may have different lengths, wherein the length of the first insertion leg may correspond to, for example, about 1.5 to 2.5 times, more specifically about 2 times the length of the second insertion leg. Furthermore, the first insertion leg may have an extension length which corresponds to, for example, about 1.05 to 1.5 times, more specifically about 1.2 times the length of the support leg.

Moreover, the second, preferably shorter insertion leg may, with respect to its inner surfaces facing the receiving-part opening area, enclose with the support leg a preferably obtuse angle of more than 90°, for example an angle of about 95° to 120°, more specifically about 100° to 110°, and in particular about 105°.

The receiving contour may have a rounding with a comparatively large radius in the transition from the inner surfaces of the first insertion leg to the support leg. The radius dimension may correspond to about 0.25 to 0.5 times the length of the first insertion leg. In a further embodiment, the transition from the support leg into the second insertion leg may likewise be rounded, but with a significantly smaller radius dimension compared with the rounding in the region between the first insertion leg and the support leg, for example about 0.25 to 0.5 times, more specifically about one third of the radius dimension between the first insertion leg and the support leg.

According to a further development, preferably in the case of the U-shaped configuration of the receiving part, the first insertion leg may be designed to be displaceable in order to change the size of the receiving-part opening area. Alternatively, in the case of an embodiment with only one insertion leg and one support leg, the displacement may serve to enlarge the receiving range of the support leg. In this way, the receiving-part opening area can be adapted at least substantially to the cross-sectional size of the workpiece to be cut, in the case of a tubular workpiece for example to its diameter. By displacing the first insertion leg in one or the opposite direction, the distance to the optionally provided second insertion leg and thus the size of the receiving-part opening area can be decreased or increased.

According to a further preferred embodiment, the first insertion leg is displaceable along the support leg. In the preferred embodiment with U-shaped configuration of the receiving part, this results in a parallel displaceability of the first insertion leg relative to the second insertion leg and along the support leg.

Advantageously, the first insertion leg may be secured against further displacement in different displacement positions. For this purpose, for example, a pin or the like insertable into the desired displacement position of the insertion leg may be provided.

Preferably, a detent retention is provided to form the securing. More preferably, up to, for example, five, ten, fifteen or more, in particular up to thirty detent positions may be realized, for example three, thirteen or twenty-three detent positions. In the embodiment with only one insertion leg and one support leg, the displacement positions of the insertion leg relative to the support leg result accordingly.

In this context, the first insertion leg may essentially be composed of a fixed insertion sub-leg rigidly connected to the support leg and thereby to the second insertion leg, and a second insertion sub-leg displaceable relative thereto along the support leg, which in a preferred basic position may together form the first insertion leg. In the preferred detented displacement position, the effective first insertion leg may be formed solely by the displaceable insertion sub-leg. The detent may, as preferred, be formed between the displaceable insertion sub-leg and the fixed insertion sub-leg. A detent between the displaceable insertion sub-leg and the support leg, or also with a stationary cutting part of the cutting tool, is likewise possible.

The securing, preferably the detent, is advantageously effective in the swung-in or retracted holding position of the receiving part, so that during the cutting operation the workpiece is reliably held in the receiving part despite the action of the movable cutting part on the workpiece.

The detent may be effective only in the holding position, preferably after the receiving part has been pivoted in or slid back from the receiving position into the holding position.

Alternatively, the detent can already be engaged in the swung-out or advanced receiving position, so that the displaceable insertion sub-leg reaches the holding position in a detented state.

If the securing or detent is provided between the displaceable insertion sub-leg and a cutting part, this cutting part may have a counter-toothing designed for preferably form-fit cooperation with a toothing of the displaceable insertion sub-leg.

The toothing of the displaceable insertion sub-leg may, according to a possible embodiment, be formed on an insert part, which insert part is in particular configured for the linearly displaceable mounting of the displaceable insertion sub-leg on the support leg of the receiving part fixed relative thereto.

A particular handling advantage is obtained if, according to a further possible embodiment, the displaceable insertion sub-leg is biased by a spring toward a basic position. For this purpose, for example, a compression or tension spring, in particular a coil tension spring, may be used.

The basic position is preferably the displacement position of the insertion sub-leg in which, viewed in the displacement direction of the insertion sub-leg, the receiving part has the smallest extent of the U-shaped configuration, i.e. the smallest spacing between the first insertion leg and the optionally provided second insertion leg. A workpiece inserted into the receiving part having an extent, for example a diameter, exceeding this smallest spacing is therefore preferably pressed, at least in the receiving position, by the spring-loaded insertion sub-leg against the stationary second insertion leg, so that the displacement position of the insertion sub-leg to be secured in the holding position can be automatically assumed in adaptation to the size of the workpiece.

It proves particularly advantageous that, in the holding position of the receiving part, a force of the second cutting part acting on the workpiece loads the receiving part—essentially via the workpiece—into the holding position. Thus, merely by performing the cutting operation, a stable positioning of the receiving part in the swung-in or retracted, preferably stop-limited position is achieved.

The ranges or multiple ranges specified hereinbefore and hereinafter also include, with respect to the disclosure, all intermediate values, in particular in increments of one tenth of the respective dimension, and possibly also dimensionless. For example, the indication 60° to 120° also includes the disclosure of 60.1° to 120°, 60° to 119.9°, 60.1° to 119.9°, etc. The indication of 1.5 to 2.5 times also includes the disclosure of 1.6 to 2.5 times, 1.5 to 2.4 times, 1.6 to 2.4 times, etc. Such disclosure may serve on the one hand for limiting a stated range boundary from below and/or above, and alternatively or additionally also for the disclosure of one or more singular values from a respectively stated range.

### BRIEF DESCRIPTION OF THE DRAWINGS

The invention is explained below with reference to the accompanying drawings, which, however, merely represent exemplary embodiments. A component that is explained only in connection with one of the exemplary embodiments and, in another exemplary embodiment, is not replaced by another component due to the particularity highlighted therein, is thereby also described for this further exemplary embodiment as a possible component. The drawings show:

FIG. 1: the cutting tool in a first embodiment;

FIG. 2: the cutting tool in a first embodiment, schematically showing the application;

FIG. 3: the cutting tool according to FIG. 1 in a partially sectional side view, relating to a swung-out receiving position of a receiving part;

FIG. 4: a subsequent view to FIG. 3, showing an intermediate position during pivoting of the receiving part, which accommodates a workpiece to be cut, toward a holding position;

FIG. 5: the cutting tool with the receiving part in the holding position;

FIG. 6: a subsequent view to FIG. 5, showing an intermediate position during a cutting operation;

FIG. 7: a view essentially corresponding to FIG. 6, but with accommodation of a workpiece having a reduced diameter compared with the workpiece in FIG. 6;

FIG. 8: a further view essentially corresponding to FIG. 6, but with accommodation of a workpiece having an even further reduced diameter compared with the workpiece in FIG. 6;

FIG. 9: the cutting tool in a position at the moment of completion of the cutting operation;

FIG. 10: the region of a cutting mouth of the cutting tool provided with the receiving part in enlarged representation;

FIG. 11: in exploded perspective view, the region of the cutting mouth of the cutting tool and the receiving part assignable thereto, further with a workpiece to be cut;

FIG. 12: the receiving part in an individual view, in a view according to arrow XII in FIG. 11;

FIG. 13: the cutting tool in a second embodiment, relating to the receiving position of the receiving part;

FIG. 14: a view essentially corresponding to FIG. 13, with the receiving part pivoted into a holding position;

FIG. 15: the region XV in FIG. 14, in a partially sectional representation of the receiving part;

FIG. 16: the front view of the cutting tool according to arrow XVI in FIG. 14;

FIG. 17: the receiving part in a view according to arrow XVII in FIG. 15;

FIG. 18: the receiving part in a view according to arrow XVIII in FIG. 17;

FIG. 19: the section along line XIX-XIX in FIG. 18, relating to a first displacement position of an insertion leg of the receiving part;

FIG. 20: a sectional view corresponding to FIG. 19, but relating to a second displacement position of the insertion leg;

FIG. 21: a further sectional view corresponding to FIG. 19, with the insertion leg in a third displacement position;

FIG. 22: the receiving part of the second embodiment in an exploded perspective view;

FIG. 23: the top view of the receiving part according to arrow XXIII in FIG. 17;

FIG. 24: the bottom view of the receiving part according to arrow XXIV in FIG. 17;

FIG. 25: the section along plane XXV in FIG. 13, relating to the swung-out position of the receiving part;

FIG. 26: a sectional view according to FIG. 25, relating to the swung-in position;

FIG. 27: the section along plane XXVII in FIG. 14;

FIG. 28: a view essentially corresponding to FIG. 3, but relating to a third embodiment;

FIG. 29: the cutting tool of the third embodiment with a workpiece accommodated in the receiving part;

FIG. 30: the cutting tool according to FIG. 29 with the receiving part in the holding position;

FIG. 31: the cutting tool in a further embodiment, relating to the receiving position of the receiving part;

FIG. 32: a view corresponding to FIG. 31, with the receiving part pivoted into a holding position;

FIG. 33: an exploded perspective view of the receiving part and components of the cutting tool of the embodiment according to FIG. 31;

FIG. 34: the view according to arrow XXXIV in FIG. 32, partially sectioned;

FIG. 35: the enlarged region XXXV in FIG. 34;

FIG. 36: the section along line XXXVI-XXXVI in FIG. 35;

FIG. 37: the section along line XXXVII-XXXVII in FIG. 35;

FIG. 38: the view according to arrow XXXVIII in FIG. 32;

FIG. 39: the section along line XXXIX-XXXIX in FIG. 38, relating to the receiving position with a workpiece inserted into the receiving part;

FIG. 40: a sectional view essentially corresponding to FIG. 39, but relating to the holding position, with a workpiece of maximum diameter for this receiving part inserted into the receiving part;

FIG. 41: a sectional view essentially corresponding to FIG. 40, but with a workpiece of reduced diameter compared with the workpiece in FIG. 40 inserted into the receiving part;

FIG. 42: in side view, the cutting tool in a further embodiment, relating to the receiving position of the receiving part;

FIG. 43: a view corresponding to FIG. 42, with the receiving part displaced into the holding position;

FIG. 44: the enlarged, partially sectioned region XLIV in FIG. 43;

FIG. 45: the enlarged sectional view along line XLV-XLV in FIG. 43, with securing of the position of the receiving part by a form-fit;

FIG. 46: the enlarged region XLVI in FIG. 45;

FIG. 47: the section along line XLVII-XLVII in FIG. 46;

FIG. 48: a sectional view corresponding to FIG. 45, but relating to a release position of the form-fit securing the position of the receiving part;

FIG. 49: the enlarged region XLIX in FIG. 48;

FIG. 50: the section along line L-L in FIG. 49;

FIG. 51: in partial exploded perspective representation, the region of a linear guide of the receiving part on the cutting tool according to FIG. 42;

FIG. 52: the linear guide in a partial sectional view.

### DESCRIPTION OF EMBODIMENTS

Illustrated and described is a hand-operated cutting tool 1 having a first, stationary handle part 2 and a second, pivotable handle part 3, as well as a first, stationary cutting part 4 and a second cutting part 5 pivotable relative to the cutting part 4, and furthermore a receiving part 6.

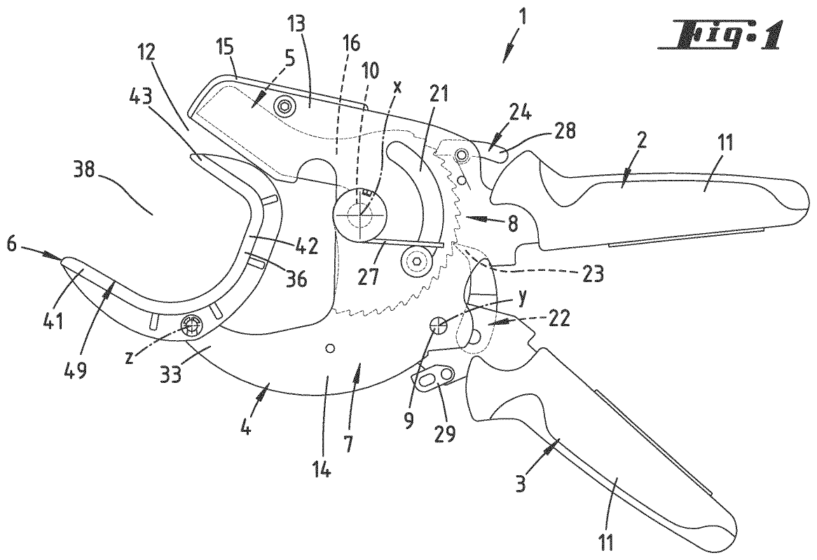

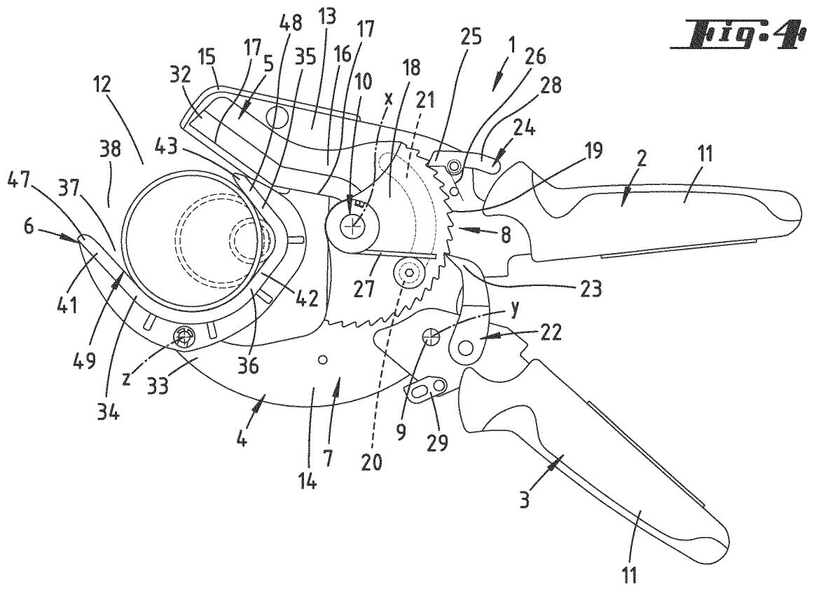

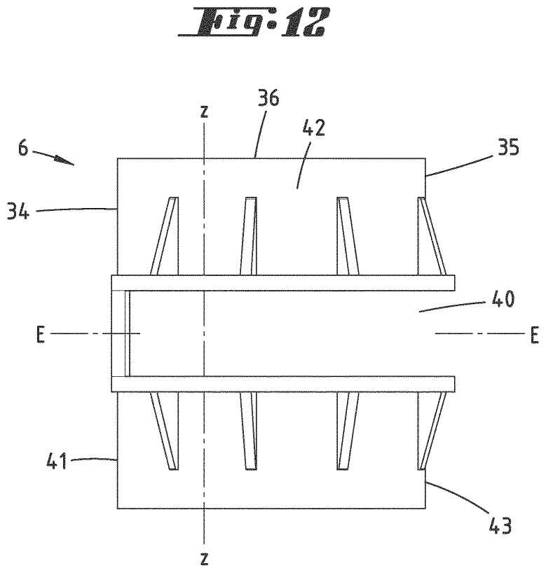

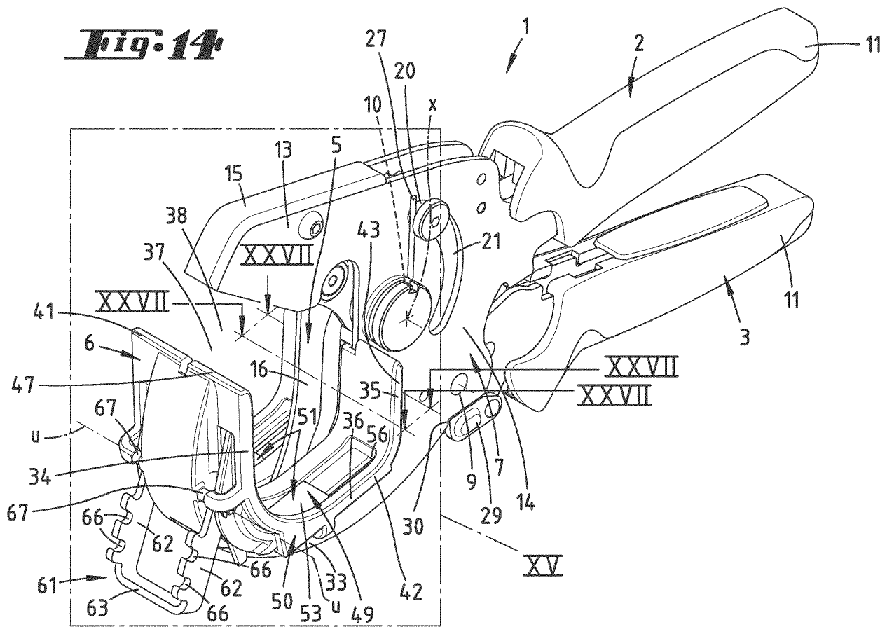

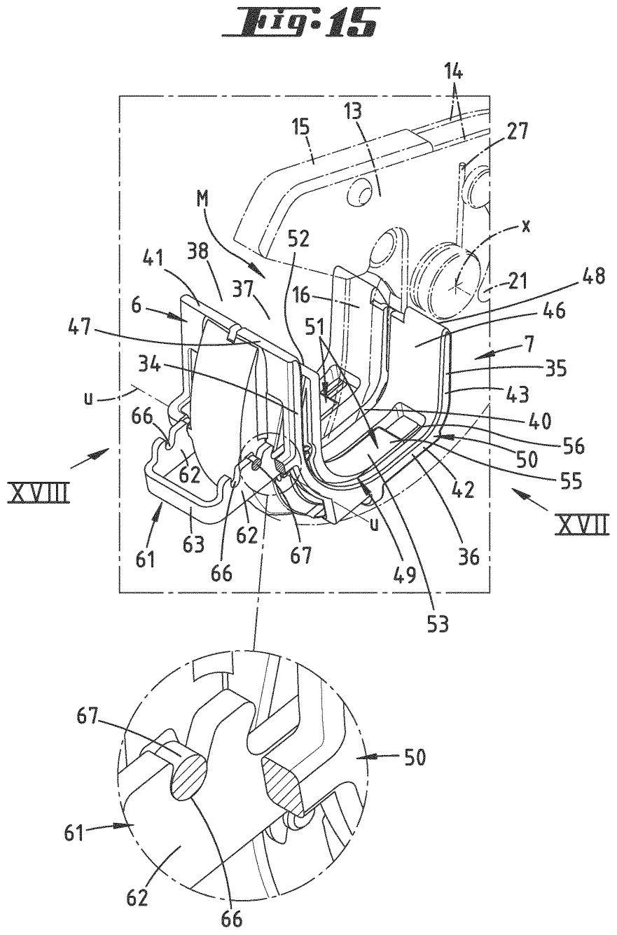

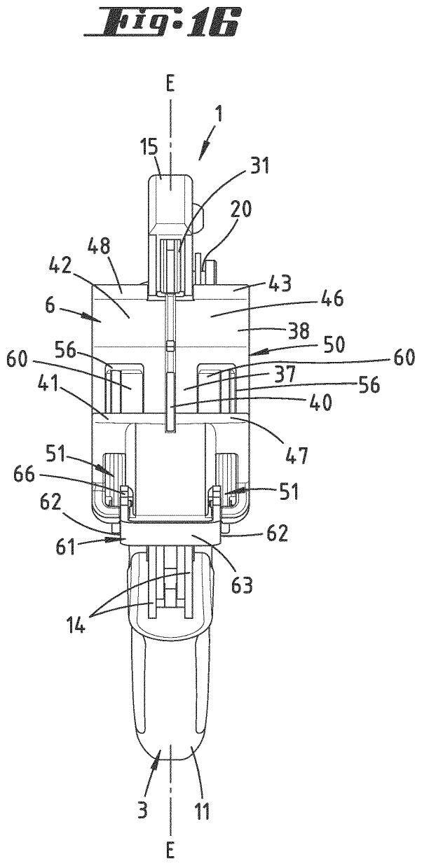

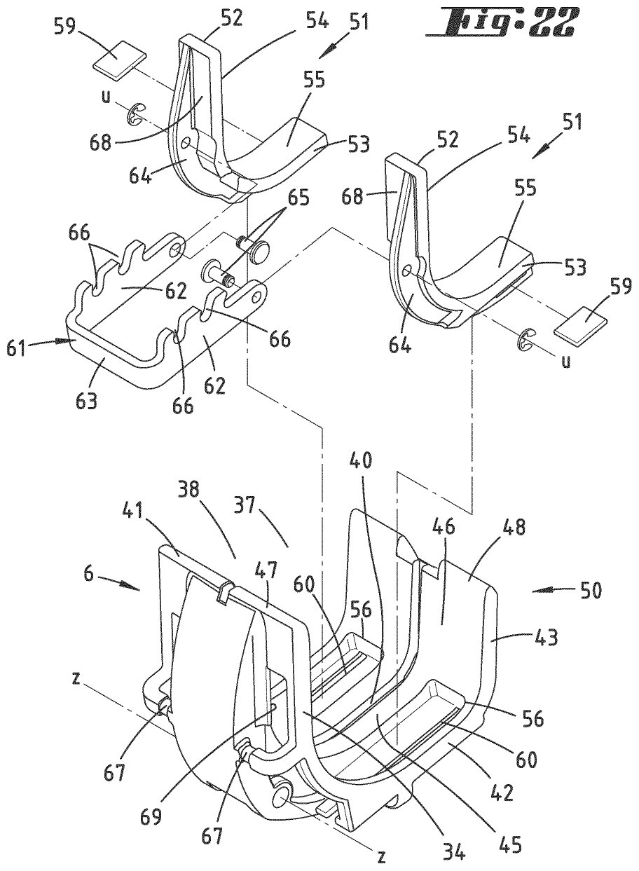

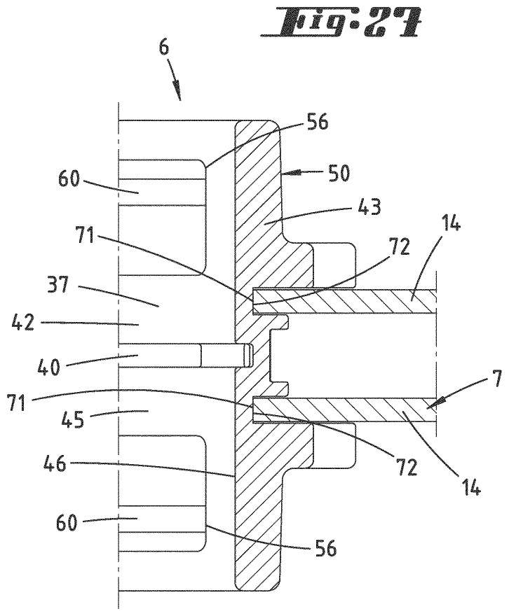

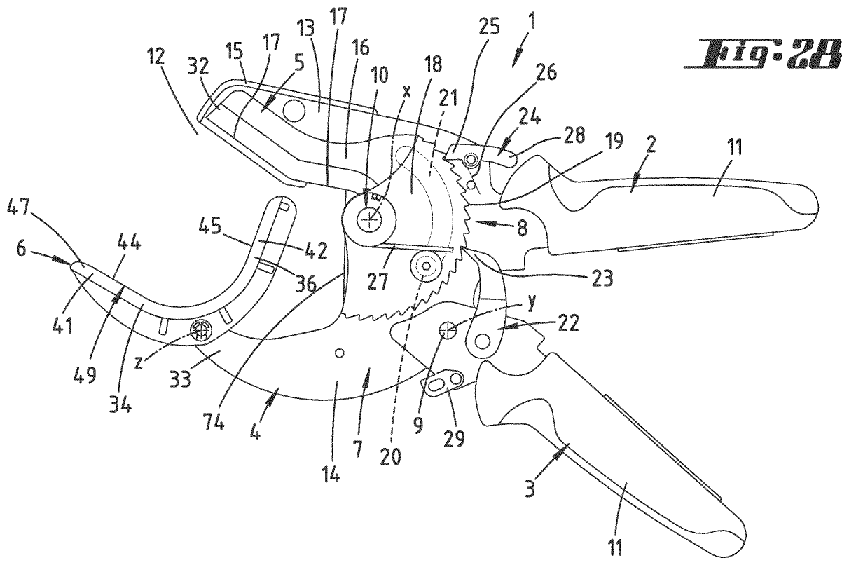

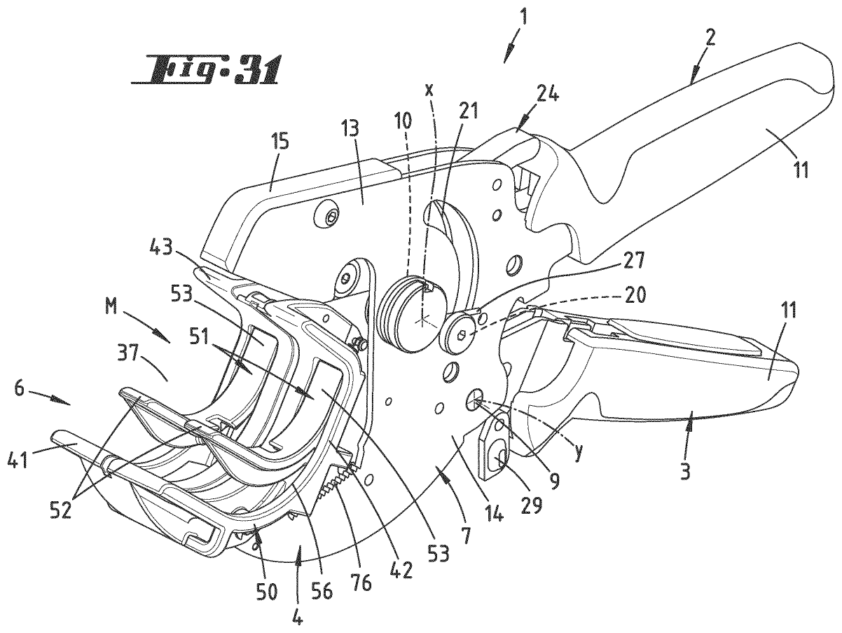

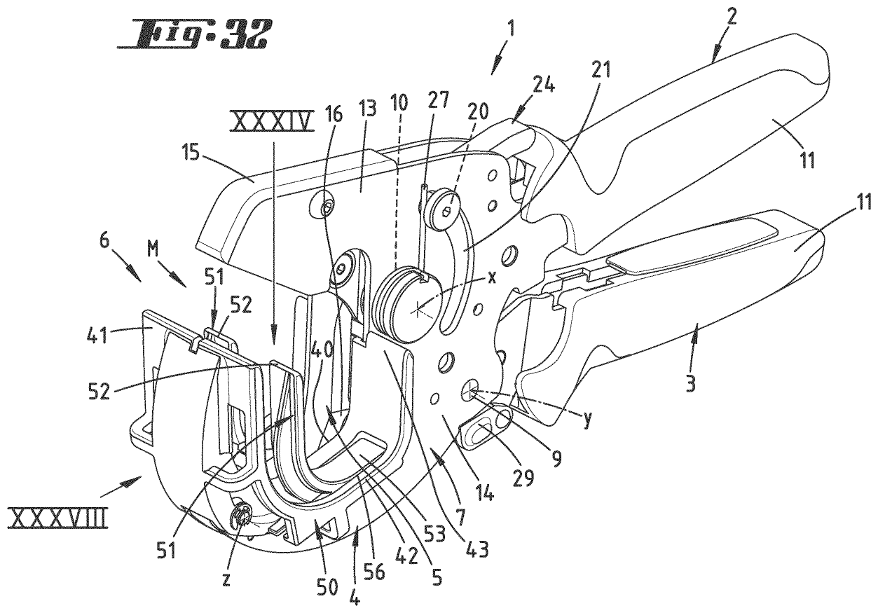

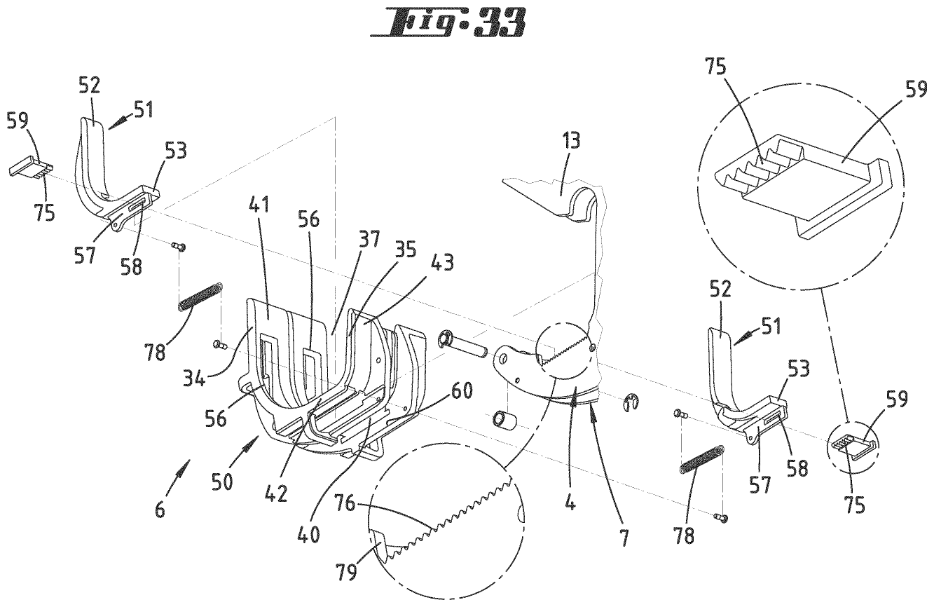

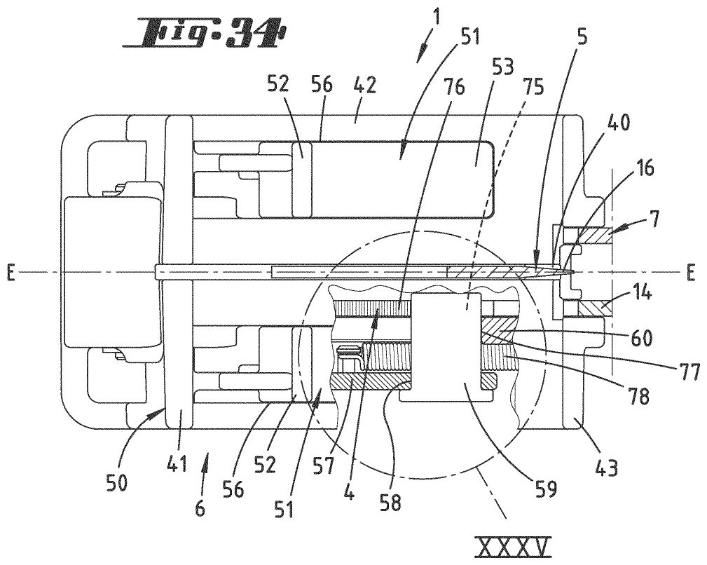

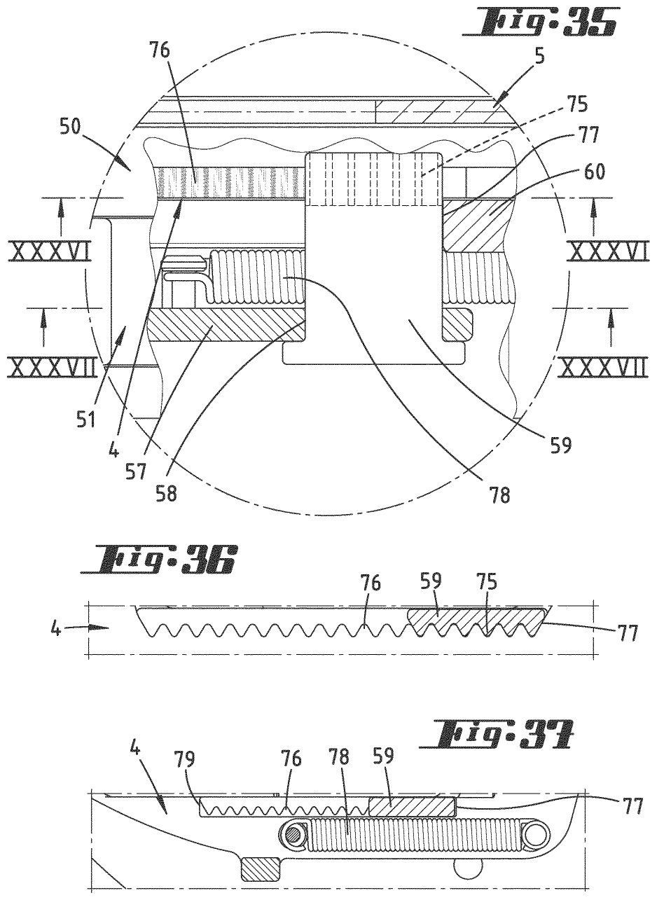

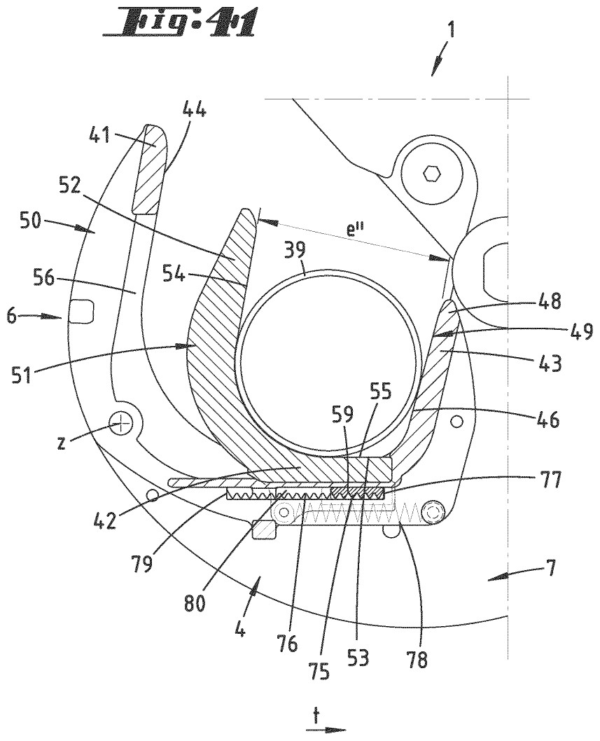

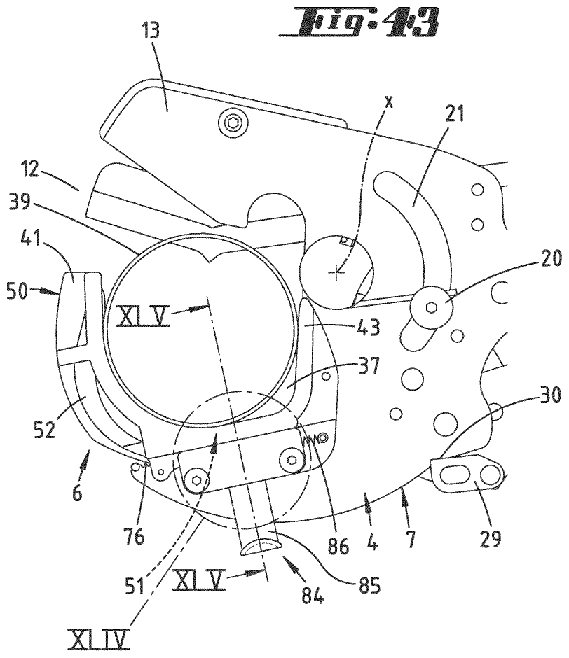

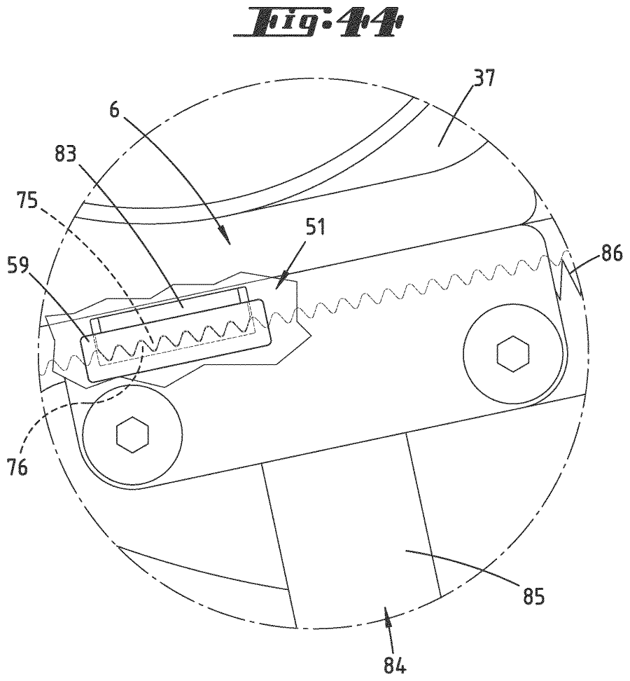

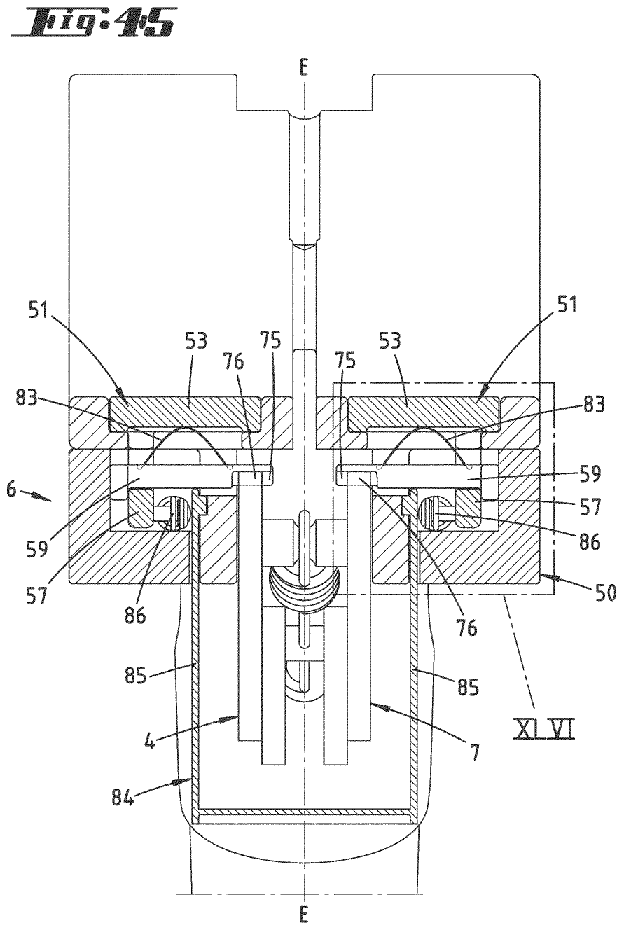

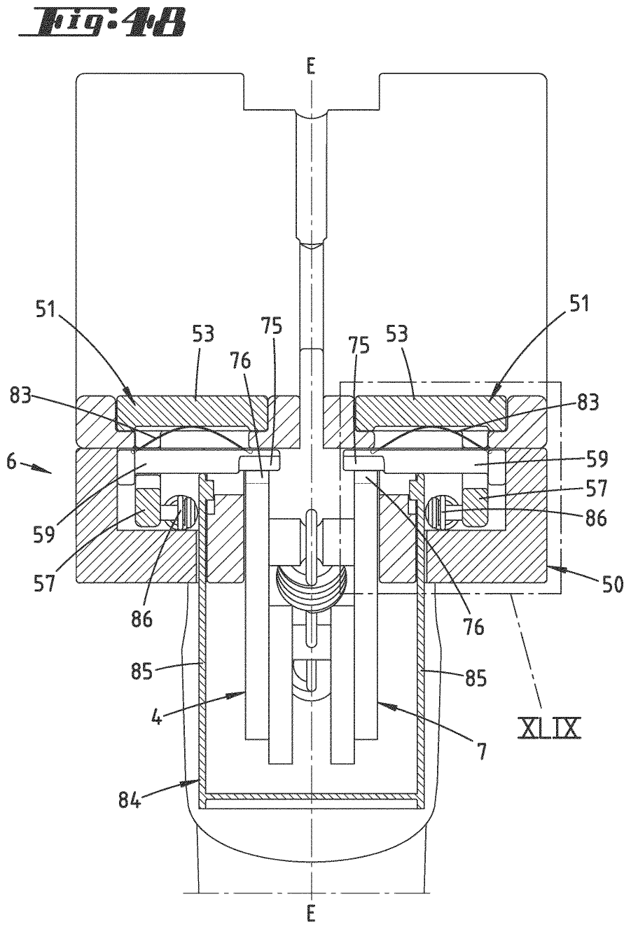

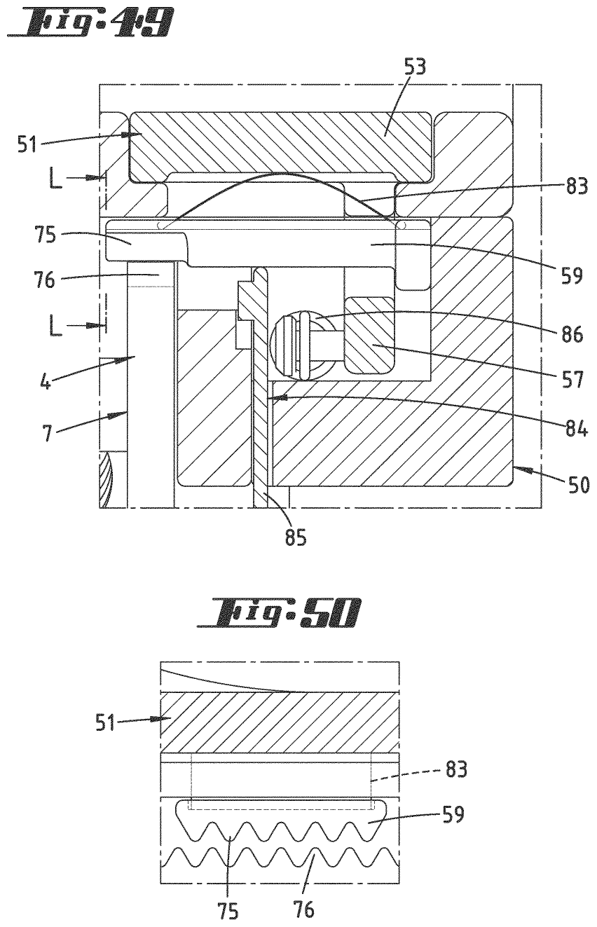

FIGS. 1 to 12 show a first embodiment of the cutting tool 1. FIGS. 13 to 27 relate to a second embodiment, based on the first embodiment, with an adjustable receiving part 6. A third embodiment is shown in FIGS. 28 to 30. FIGS. 31 to 41 show a fourth embodiment. A further embodiment, essentially based on the fourth embodiment, is shown in FIGS. 42 to 52 as a fifth embodiment.

Starting from a preferably plate-like tool body 7, the first stationary handle part 2 preferably extends integrally, and more preferably in material unity. Substantially opposite to the handle part 2, the first, stationary cutting part 4 likewise preferably extends integrally and, more preferably, in material unity, in the manner of a free projecting leg.

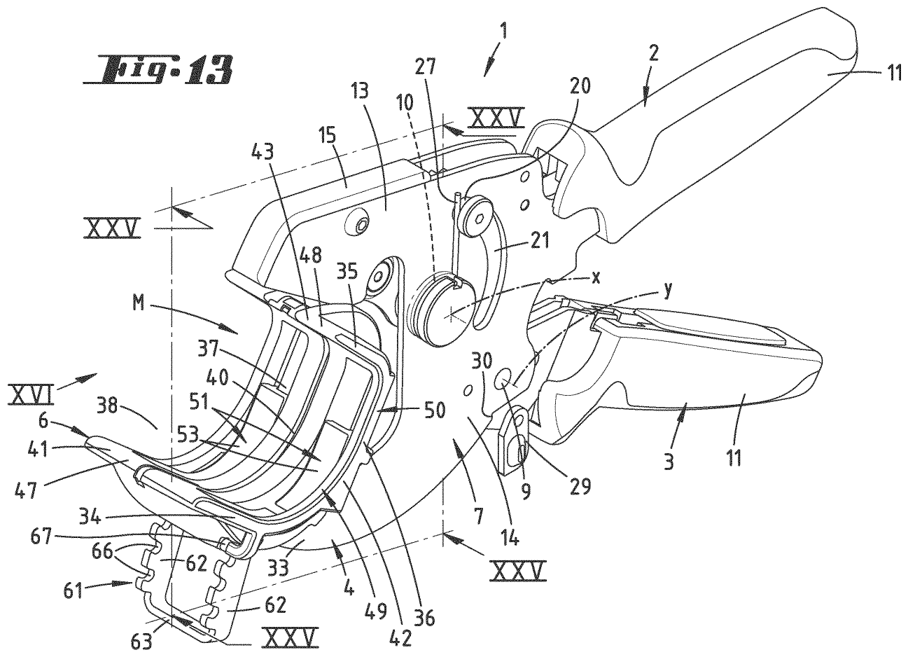

As can also be seen in particular from FIGS. 13 and 14 with regard to the second embodiment, in the cutting tool 1 of the first embodiment as well two spaced-apart, preferably plate-shaped parts 14, in particular stamped parts, more specifically stamped steel sheet parts, may form the tool body 7. These two parts 14 forming the tool body 7 may be substantially identical in design and extend spaced apart from each other in the direction of a geometric pivot axis x, described in more detail below.

Arranged between the parts 14 of the tool body 7 are substantially the second cutting part 5, movable about the pivot axis x, and preferably a ratchet drive 8. An end section of the second, pivotable handle part 3, preferably via a pivot pin 9, also engages in the intermediate space between the parts 14 of the tool body 7 and is mounted on the tool body 7. The respective geometric pivot axis y extends preferably in spatial parallelism to the geometric pivot axis x at the joint 10 of the second cutting part 5.

The handle parts 2 and 3 may, as also illustrated, each be provided with a grip sleeve 11.

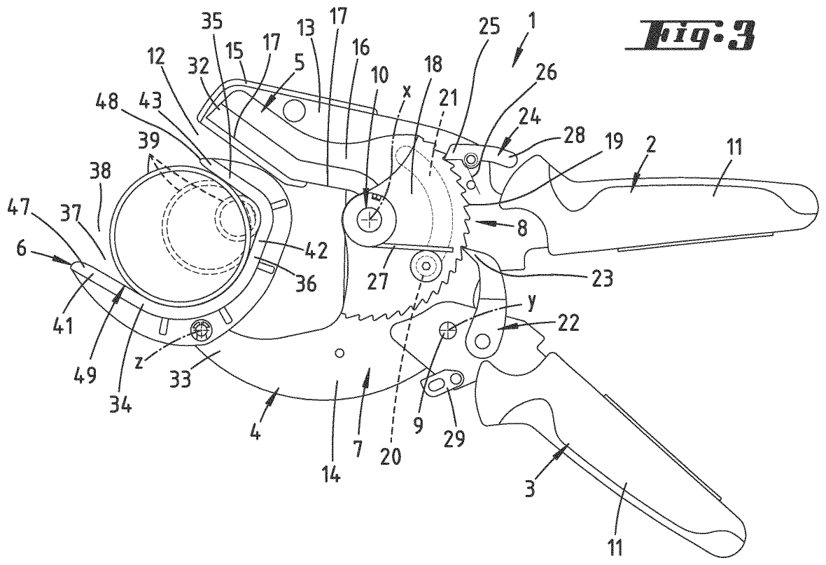

In FIGS. 3 to 10, solely for the sake of clarifying the mechanics as well as the construction and mode of operation, the front part 14 in the viewing direction has not been shown in the drawing.

Also forming part of the rigid tool body 7 is a leg 13, likewise integrally and preferably in material unity formed with the respective part 14, which, together with the tool body 7 as such and the leg-like stationary cutting part 4, bounds a substantially U-shaped cutting mouth M, with a cutting-receiving opening 12 formed by the U-opening, in a view in the direction of extension of the pivot axis x. The two sections of the parts 14 forming the leg 13 may, as also illustrated, be covered by a cap 15 made, for example, of a plastic material.

The second, pivotable cutting part 5 has a blade 16 directed toward the cutting mouth M, which, in the embodiments shown, preferably has, in the longitudinal extension of the blade 16, two cutting edges 17 enclosing an obtuse angle of about 160° to 175°.

This results in a movement of the second cutting part 5 in a cutting plane E defined between the parts 14 (cf. FIG. 15).

The blade 16 is preferably also formed integrally, optionally in material unity with a preferably plate-like ratchet section 18, which, with reference to the pivot axis x, has on its outer circumferential edge a toothing 19.

The pivotability of the second cutting part 5 as thus configured may be stop-limited, in particular in the basic position of the second cutting part 5 illustrated, for example, in FIG. 3, as a result of cooperation between a guide pin 20 and a guide groove 21 formed in the parts 14 of the tool body 7 and extending coaxially to the pivot axis x. In this stop-limited basic position, the second cutting part 5, particularly the section forming the blade 16, may be accommodated substantially completely between the tool-body sections forming the leg 13, in a protected, hidden position.

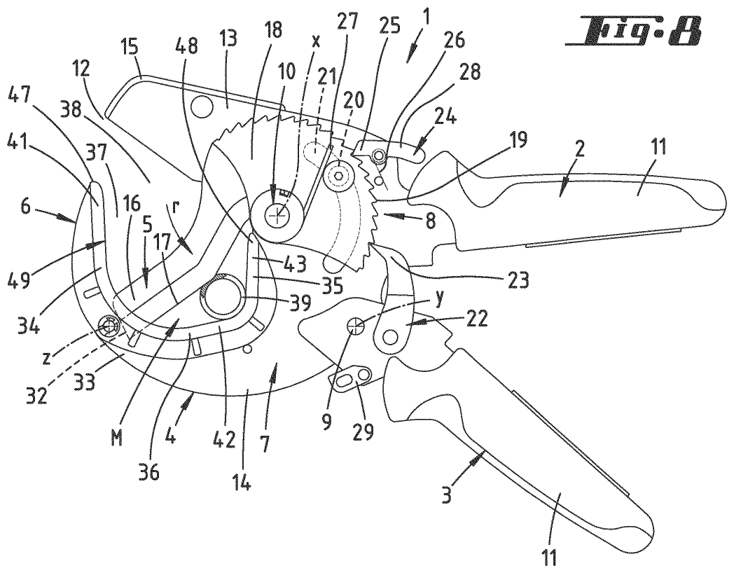

In the course of a pivot displacement of the second cutting part 5, starting from the basic position in a pivoting direction r, the guide pin 20 passes through the guide groove 21. Even in an end pivot position, as illustrated, for example, in FIG. 9, a stop-limitation may be present due to abutment of the guide pin 20 at the relevant end of the guide groove 21.

In the embodiment shown, and preferably, the pivot displacement of the second cutting part 5 in the pivot direction r takes place using the ratchet drive 8. For this purpose, the handle part 3 may be provided with a feed lever 22 pivotably mounted thereon. This feed lever 22 engages, with a free end feed finger 23, into the toothing 19 of the ratchet section 18 on the cutting part. Pivoting the second handle part 3 toward the handle part 2 that is stationary relative thereto causes, via the engagement of the feed finger 23 in the toothing 19, a partial pivot displacement of the second cutting part 5. A pawl lever 24, likewise pivotably mounted on the tool body 7, in particular between the parts 14, prevents, with a pawl finger 25 likewise engaging in the toothing 19, a return displacement of the pivotable cutting part 5 counter to the pivot direction r, such that, even when the pivotable handle part 3 is pivoted back into a position spaced from the stationary handle part 2, the second cutting part 5 remains in the previously reached pivot position.

Both the feed lever 22 and the pawl lever 24 are, in a customary manner, biased into their engagement positions with the toothing 19 by springs, in particular leg springs, such as the leg spring 26 of the pawl lever 24. In each case, one leg of the spring acts on the respective lever, while the other leg of the spring is preferably supported on the rigid tool body 7.

The advance displacement of the second cutting part 5 in the pivot direction r proceeds against the force of a return spring 27 acting on the second cutting part 5. As also shown, a leg spring may be provided for this purpose, which with one leg is supported on the rigid tool body 7, and with its other leg acts, counter to the pivot direction r, on the guide pin 20.

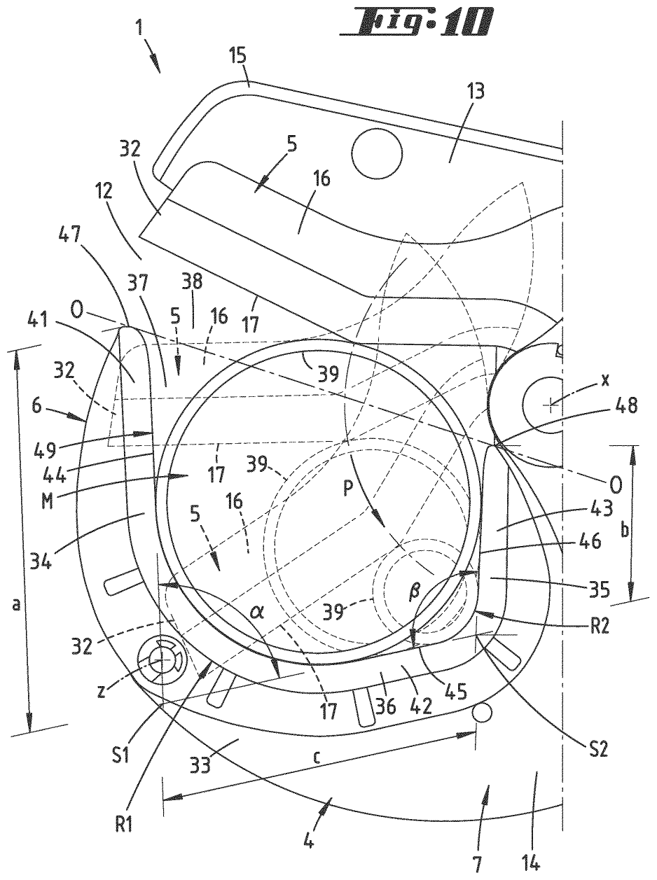

During the advance displacement of the second cutting part 5 in the pivot direction r, the blade 16 passes at least with a portion thereof, and more particularly with a free end 32 of the second cutting part 5, through a first insertion slot 31 formed between the legs of the tool body 7 that form the first, stationary cutting part 4. This insertion slot 31 may, as preferred, be provided by the spaced-apart course of the parts 14 as a whole (see, for example, FIG. 11).

Furthermore, it is preferred that during the advance displacement and entry or passage through the insertion slot 31, the movable cutting part 5, and thus also the free end 32 of the second cutting part 5, does not project outward beyond the outer edge contour of the stationary cutting part 4 as viewed in the viewing direction toward the pivot axis x. Rather, in particular the free end 32 is covered on both sides within the insertion slot 31 by the leg sections of the parts 14 that form the stationary cutting part 4.

The pawl lever 24 may have, opposite the pawl finger 25, a handle 28 exposed to the outside and thus accessible, by means of which the pawl lever 24 can be pivoted such that its pawl finger 25 disengages from the toothing 19. The second cutting part 5 can then, under the action of the return spring 27, pivot back from the advanced position, while the feed finger 34 ratchets over, into the basic position, for example as in FIG. 3.

In addition, the pivotable handle part 3 may be provided with a locking lever 29 which, in a locking position, can cooperate in a blocking manner with a locking edge 30 of the tool body 7.

At the free end 33 of the stationary cutting part 4, which is remote from the handle parts 2 and 3, the receiving part 6 is arranged pivotably. The associated pivot axis z preferably extends spatially parallel to the geometric pivot axes x and y of the joint 10 and of the pivotable handle part 3; moreover, and likewise preferably, the geometric pivot axes of the previously described feed lever 22, of the pawl lever 24 and, where applicable, also of the locking lever 29 can extend spatially parallel to the aforementioned geometric pivot axes.

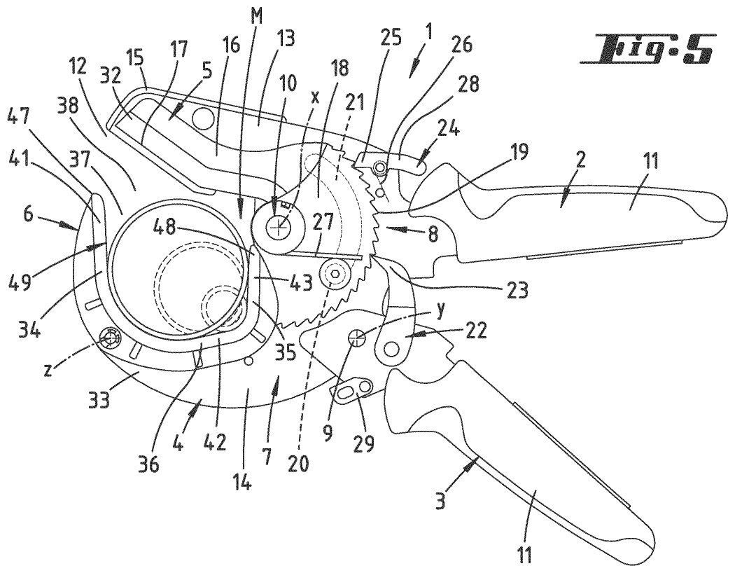

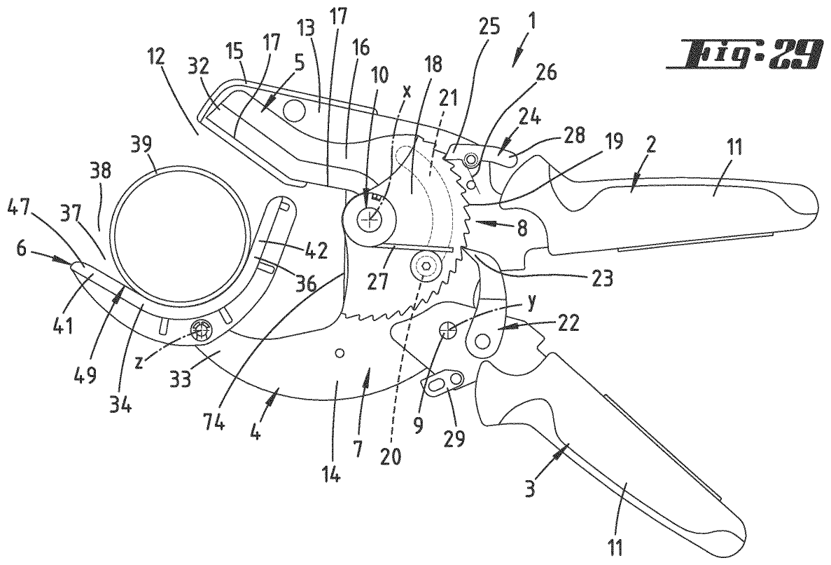

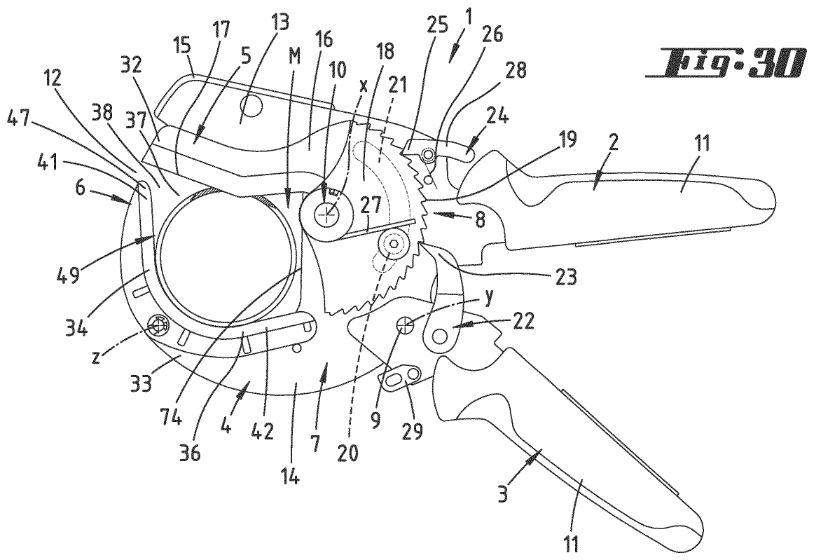

The receiving part 6 is pivotable between a swung-out receiving position, as shown for example in FIGS. 1 to 3 or also in FIG. 13 or 28, and a holding position for a workpiece 39, for example a plastic pipe, for performing a cutting operation. Such a holding position is shown, for example, in FIG. 5 or 30. Both the receiving position and the holding position of the receiving part 6 can, as preferred, be defined by a stop-limited pivotability of the receiving part. The pivot angle of the receiving part 6 from the receiving position into the holding position may be about 60° to 70°.

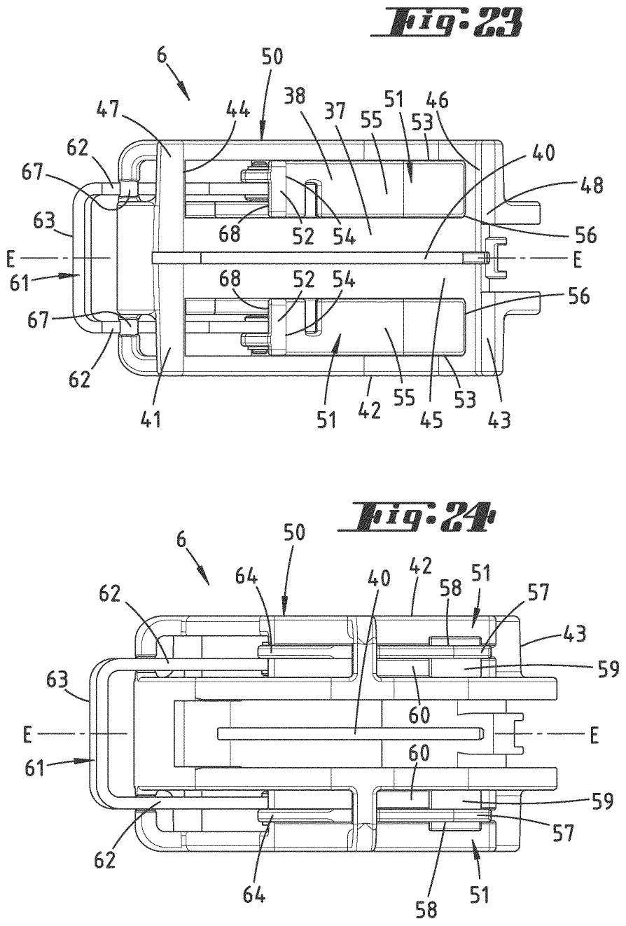

The respective stop limitation is illustrated in FIGS. 25 to 27 based on the second embodiment. However, this may also be used in the first embodiment described.

Thus, the receiving part 6 may have, assigned to an underside of the first insertion leg 41, a free-standing stop shoulder 70 which, in the receiving position of the receiving part 6 according to FIG. 25, bears in a stop-limited manner against an associated edge surface 73 of the free end 33 of the first cutting part 4.

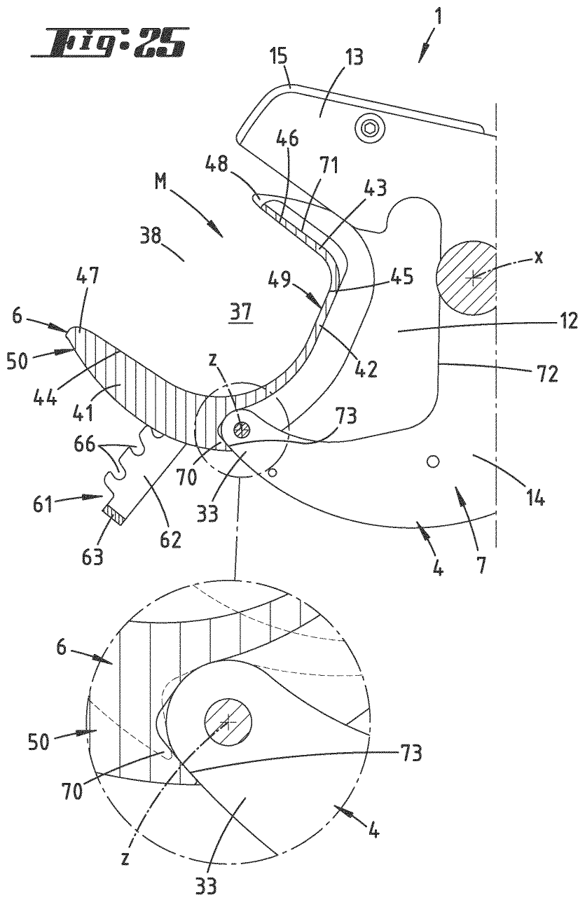

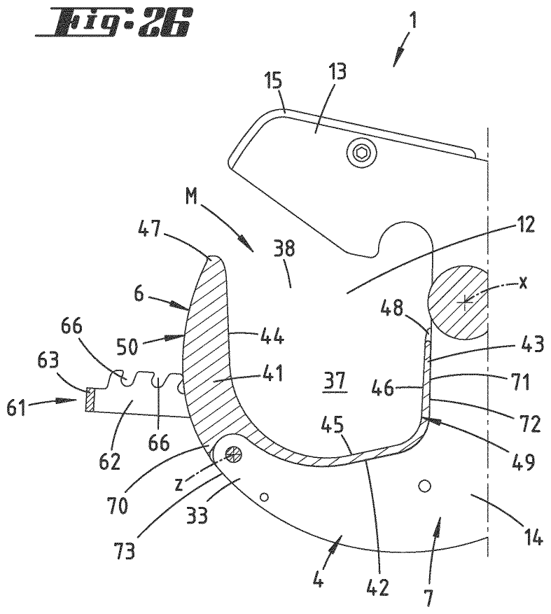

In the swung-in holding position, a stop limitation for the receiving part 6 may be provided by the receiving part 6 resting against the adjacent edge contour of the cutting mouth M. In particular, a surface 71, formed on the inside by a U-leg and a U-web which form the abutment surfaces 45 and/or 46, may come to bear against the adjacent receiving-boundary surface 72 (see FIGS. 26 and 27).

In the embodiment formed only by the insertion leg and the support leg, only the support leg may come to bear against the corresponding receiving-boundary surface 72 of the cutting mouth M.

Viewed perpendicular to the cutting plane E, the receiving contour 49 of the receiving part 6 may have an overall substantially U-shaped configuration, with two U-legs, a first U-leg 34 and a second U-leg 35, and a U-web 36 connecting the U-legs. The U-legs 34 and 35 and the U-web 36, with their abutment surfaces 44, 45, and 46, bound a receiving space 37 with a receiving opening 38 which, in the swung-out receiving position, is oriented essentially in the same direction as the cutting-receiving opening 12 of the cutting mouth M, so that a workpiece 39 to be introduced into the receiving part 6 passes through both the cutting-receiving opening 12 and the receiving opening 38.

Such a U-shaped configuration of the receiving part 6 is shown in the two embodiments of the cutting tool 1 according to FIGS. 1 to 27.

By contrast, FIGS. 28 to 30 show an embodiment in which the receiving part 6 has, in particular in the region of the resulting receiving contour 49, essentially an L-shaped configuration, with a U-leg 34, which, as explained in more detail below, forms an insertion leg 41, and a U-web 36, which, as likewise explained in more detail below, forms a support leg 42.

The receiving part 6 may, and preferably does, take the form of a plastics part, in particular a plastic injection-molded part. A one-piece, and preferably materially integral, configuration of the receiving part 6 as a whole is likewise preferred. The articulation of the receiving part 6 on the stationary cutting part 4 is preferably provided in the region of a transition between the first U-leg 34 and the U-web 36.

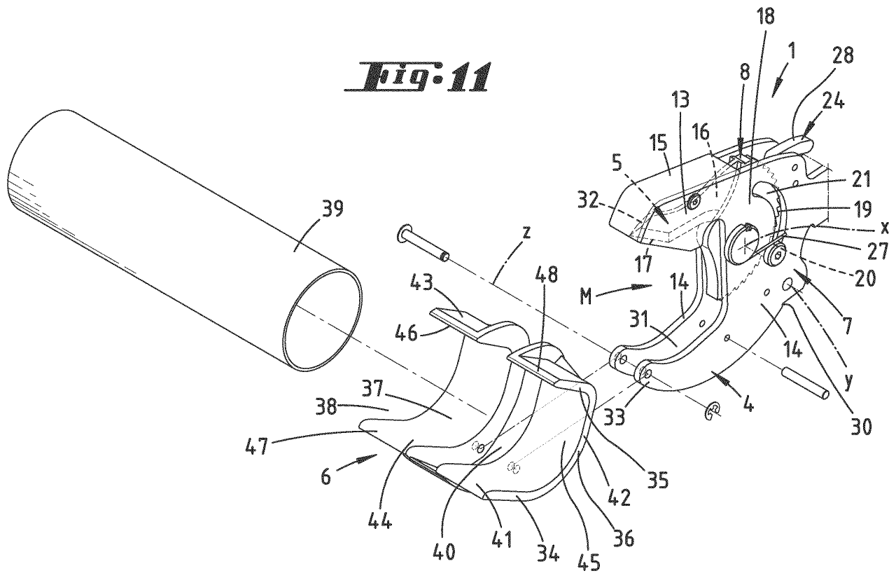

Assigned to the cutting plane E, a second insertion slot 40 is formed in the receiving part 26 for the second, pivotable cutting part 5, in particular for its blade 16 (cf. FIGS. 11 and 12).

The first U-leg 34 preferably forms a first insertion leg 41, and the U-web 36 forms a support leg 42 extending approximately at right angles thereto. The further U-leg 35 may additionally form a second insertion leg 43.

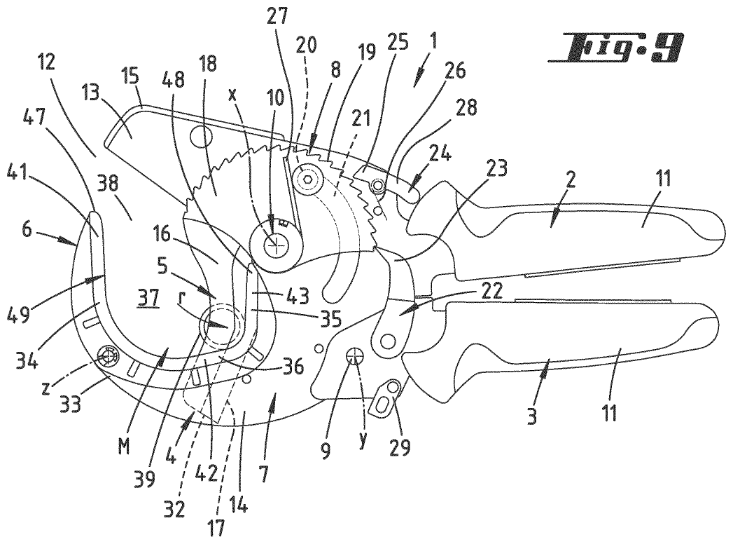

In a view perpendicular to the cutting plane E, both in the regions of the insertion legs 41 and 43, or, in the case of an L-shaped receiving part 6, only in the region of the insertion leg 41, and in the region of the support leg 42, straight and planar abutment surfaces 44 to 46 are obtained. In this case, in accordance with the schematic illustration in FIG. 10, the abutment surfaces 44 and 45 of the first insertion leg 41 and of the support leg 42 may include an acute angle α of about 75° to 85°, more particularly about 80°, while, with a U-shaped receiving part 6, an obtuse angle β of about 100° to 110°, more particularly about 105°, may be established between the abutment surfaces 45 and 46 of the support leg 42 and of the second insertion leg 43.

Starting in each case from an intersection point S1 and S2 of the notional extensions of the abutment surfaces 44 and 45, or 45 and 46, along the abutment surfaces 44 or 46 up to an opening plane O running perpendicular to the cutting plane E and touching the free ends 47 and 48 of the insertion legs 41 and 43 (cf. FIG. 10), different lengths a and b of the insertion legs 41 and 43 are obtained. Thus, as preferred, for the first insertion leg 41, a length a may be provided which corresponds to about 1.5 to 2.5 times, more particularly about 2 times, the length b of the second insertion leg 43. The length c of the support leg 42, resulting from the extension of the abutment surface 45 of the support leg 42 up to the intersection points S1 and S2, may correspond to about 0.75 to 0.9 times, more particularly about 0.8 times, the length a of the first insertion leg 41.

In a further embodiment, the transitions between the abutment surfaces of the insertion legs and the abutment surface of the support leg are rounded. Thus, between the abutment surface 44 of the first insertion leg 41 and the abutment surface 45 of the support leg 42, a radius R1 may be provided which corresponds to about 2.5 to 3.5 times, more particularly about 3 times, the radius R2 between the abutment surface 46 of the second insertion leg 43 and the abutment surface 45 of the support leg 42. Furthermore, the radius R1 between the abutment surface 44 of the first insertion leg 41 and the abutment surface 45 of the support leg 42 may correspond to about 0.35 to 0.6 times, more particularly about 0.5 times, the length a of the first insertion leg 41.

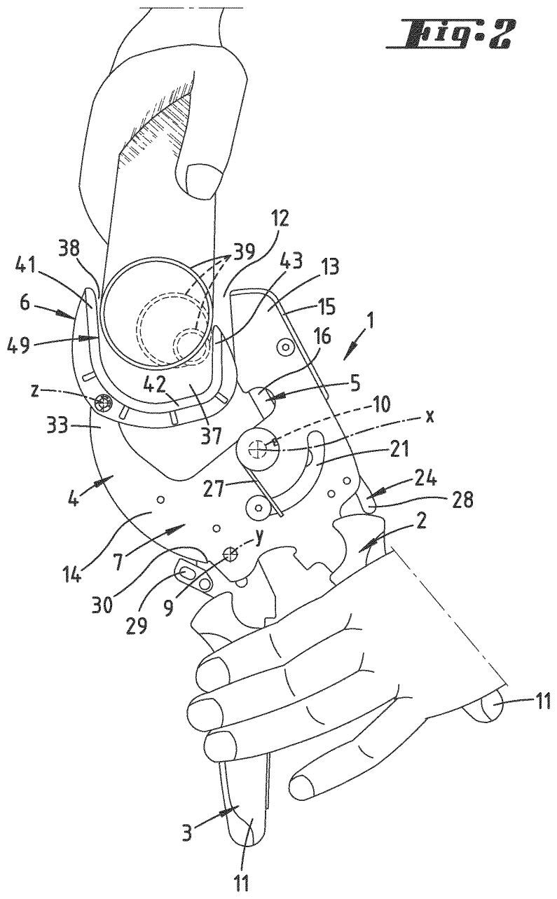

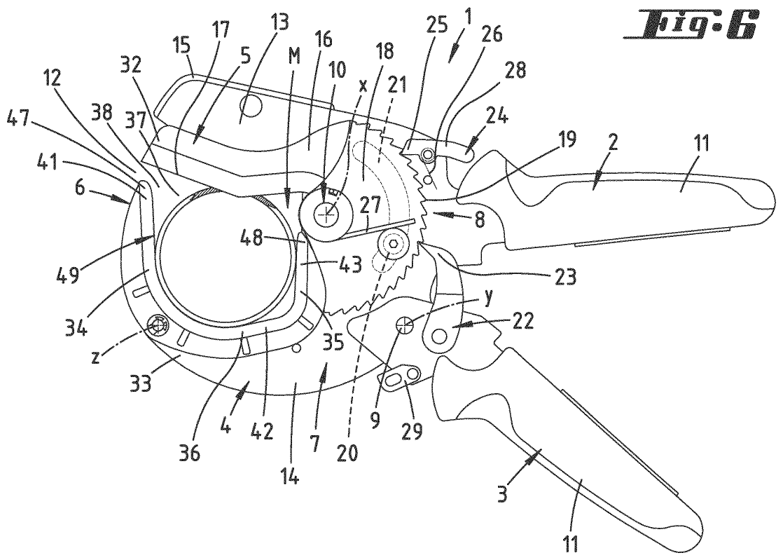

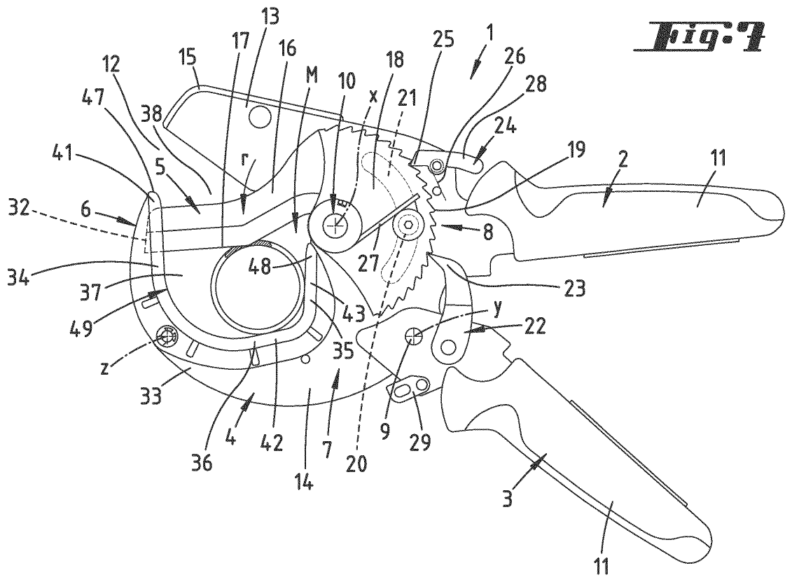

With the aid of the receiving part 6, workpieces 39 with different cross-sectional dimensions, particularly pipe diameters, can be brought into the cutting position. By way of example, three possible different workpiece diameters are shown in FIGS. 2 to 5 and 10. For the largest workpiece diameter shown, the workpiece may bear both on the first insertion leg 41 and the support leg 42, as well as on the second insertion leg 43 (see also FIG. 6), whereas with a workpiece 39 of reduced diameter, bearing may optionally occur only on the support leg 42 and the second insertion leg 43, or optionally only in the region of the radius portion with radius R2 formed between the support leg 42 and the second insertion leg 43 (cf. FIGS. 7 and 8).

In the essentially L-shaped configuration of the receiving part 6 as shown in FIGS. 28 to 30, in the holding position, when the workpiece 39 is supported on the support leg 42, the workpiece 39 may additionally bear against a surface which, in the holding position, extends substantially transversely to the abutment surface 44 of the support leg 42, which surface is formed by the tool body 7 and delimits the cutting mouth M toward the handle-part-bounding shoulder 74

As shown in the illustrations relating to the second embodiment in FIGS. 13 to 27, and explained in more detail below, the first insertion leg 41 may also be displaceable relative to the second insertion leg 43, in order to adapt the spacing between the insertion legs to the cross-sectional dimension, in particular the diameter, of the workpiece 39 to be cut.

The receiving part 6 together with the inserted workpiece 39 is pivoted about the pivot axis z into the holding position, for example according to FIG. 5, whereby in the holding position an extensive enclosure of the workpiece 39 can be achieved, the first insertion leg 41 substantially closing the cutting mouth M in the direction of the cutting-receiving opening 12 before the start of a cutting operation. This results in a secure reception of the workpiece 39 in the cutting mouth M.

In the swung-in holding position of the receiving part 6, it preferably bears in a stop-limited manner against the stationary cutting part 4 or the legs 13 of the parts 14, substantially covering, with the abutment surface 45 of the support leg 42 and, in addition, optionally also with the radius sections having radii R1 and R2 of the abutment surfaces, the adjacent edge surfaces of the legs 13. In particular, during the cutting operation the second insertion leg 43, together with the support leg 42, forms a support for the workpiece 39, whereby a force P of the second cutting part 5 acting on the workpiece 39 via the movable cutting part 5 or the blade 16 loads the receiving part 6 together with the workpiece 39 further into the swung-in position (cf. FIG. 10).

The receiving contour 49 of the receiving part 6 is not penetrated in any pivot position of the receiving part 6 by an outermost edge of the first cutting part 4 or of the legs 13. The receiving space 37 accommodating the workpiece 39 and the cutting mouth M formed in the region of the receiving space 37 are therefore, in every pivot position of the receiving part 6, bounded solely by the abutment surfaces of the receiving part 6.

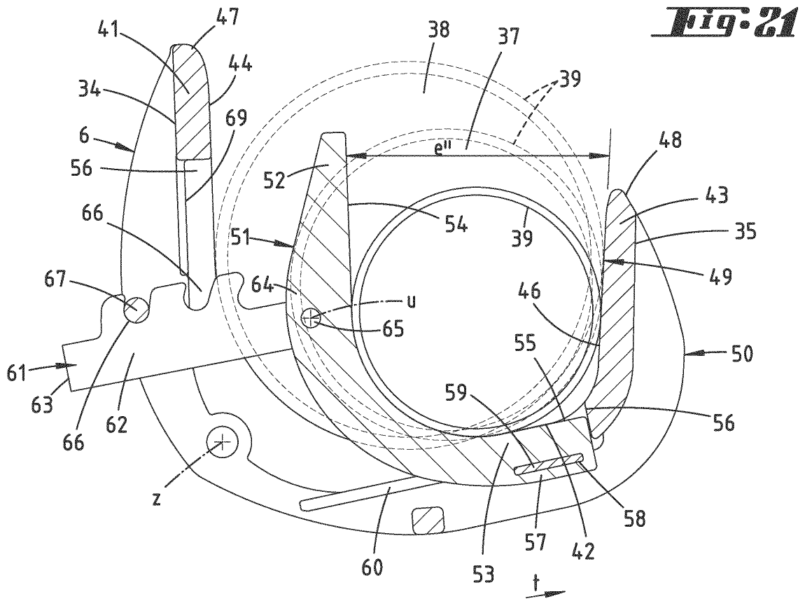

In order to permit an adaptation in particular of the first insertion leg 41 to the cross-sectional dimension, especially the diameter, of the workpiece 39, the receiving part 6 may initially have a fixed part 50 substantially reproducing the U-shaped receiving contour 49, which, as described above, is pivotally articulated about the axis y at the free end 33 of the stationary cutting part 4. In essence, the fixed part 50 thereby forms the second insertion leg 43 and regions of the support leg 42 and of the first insertion leg 41 (cf. FIG. 22).

Furthermore, in the second embodiment the receiving part 6 comprises, on either side of the second insertion slot 40, a sliding part 51. These sliding parts 51 are preferably formed and arranged substantially symmetrically with respect to the cutting plane E, each having, when viewed essentially in a direction perpendicular to the cutting plane E, an abutment sub-leg 53 and an insertion sub-leg 52, whose abutment surface portions 54 and 55 are connected to one another via a rounding of radius R1.

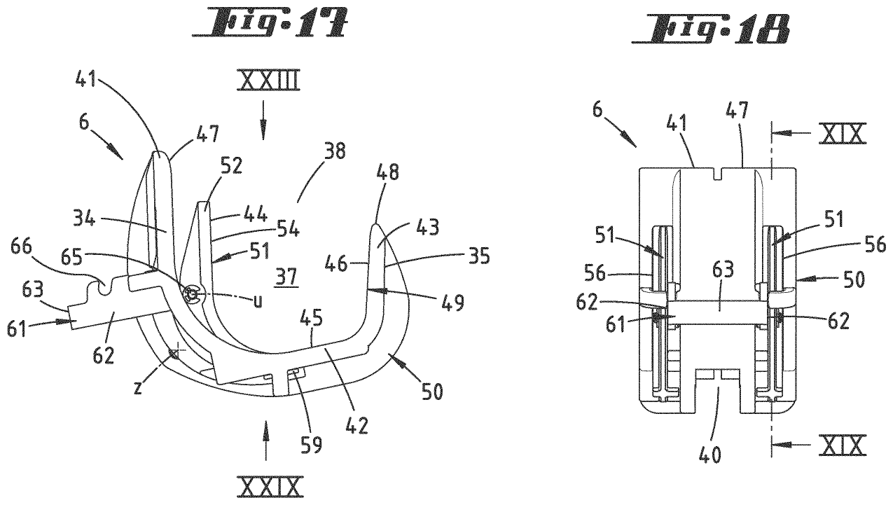

The sliding parts 51 are received in window-like cutouts 56 of the fixed part 50 provided on either side of the cutting plane E. These cutouts 56 are dimensioned such that, in a stop-limited basic position according to FIG. 19, the sliding parts 51 merge flush with their abutment surface portions 54 and 55 into the adjacent abutment surfaces 44 and 45 of the fixed part 50. The length of the cutout 56 in the displacement direction t of the sliding parts 51 in the region of the support leg 42 of the fixed part 50 is selected, compared with the length of the support-leg section 53 of the sliding part 51 considered in the same direction, such that a linear displacement of the sliding part 51 along the fixed-part support leg 42 is possible over a length d (see FIG. 19).

On the underside of the abutment sub-leg 53 there extends a web 57 which also passes through the cutout 56 and has a slot opening 58, through which a plate-shaped insert part 59 is insertable. This insert part 59 under-engages a shoulder 60 of the fixed part 50 that extends in the displacement direction t, whereby the sliding part 51 is retained captively on the fixed part 50 but is slidably displaceable in the displacement direction t.

The sliding parts 51 are further preferably displaceable only as a pair. For this purpose, the sliding parts 51 may be provided with a substantially U-shaped connecting bracket 61. The U-legs 62 of the bracket are pivotally connected at their free ends remote from the U-web 63 to webs 64 provided rearward of the insertion sub-legs 52 of the sliding parts 51. As apparent from FIG. 22, for this purpose securing pins 65 may be provided, which pass through the end regions of the U-legs 62 as well as the webs 64 of the sliding parts 51 in correspondingly positioned bores. This results in a geometric pivot axis u, which preferably runs spatially parallel to the pivot axis y of the receiving part 6 as a whole.

The connecting bracket 61 likewise projects outward through the cutouts 56 according to the arrangement described above. In the region of the U-legs 62, detent recesses 66 open toward the edge are formed. In the embodiment shown, two such detent recesses 66 are provided on each U-leg 62, which are designed to cooperate in a detent manner with a pin-shaped detent portion 67 of the fixed part 50.

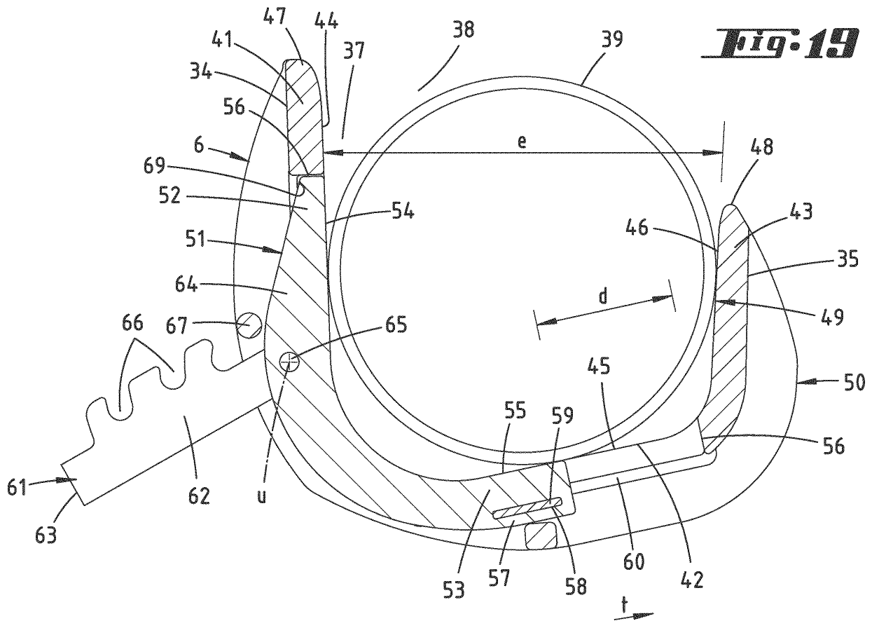

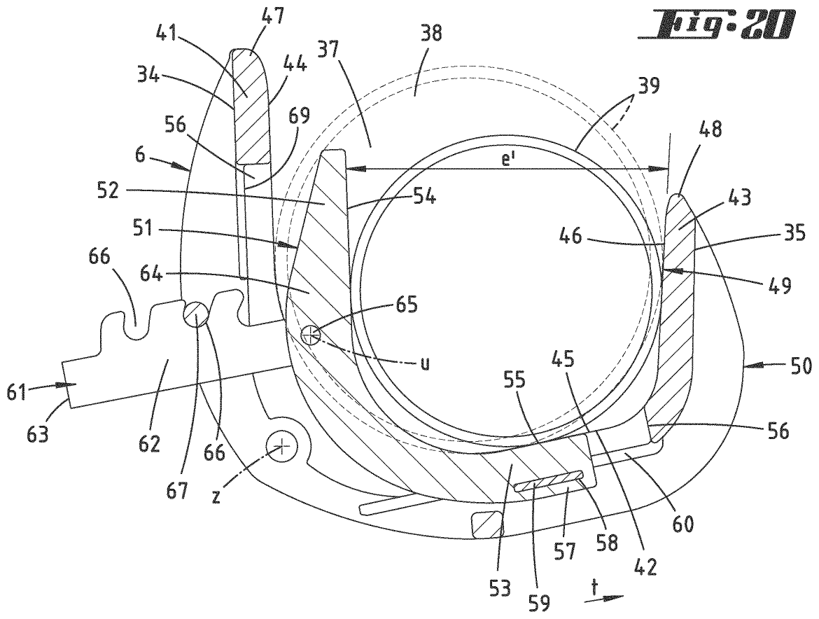

As shown in particular in FIGS. 19 to 21, at least three displacement positions of the sliding parts 51, and thus of the effective section of the first insertion leg 41, can thus be obtained: a basic position according to FIG. 19, in which the sliding parts 51 bear in a stop-limited manner with a surface 68 formed on the rear side of the insertion sub-leg 52 against a counter-surface 69 of the fixed part 50 delimiting the cutout 56; a first detent position according to FIG. 20, in which a first detent recess 66 of the connecting bracket 61 is brought into a detent connection with the detent portion 67, the sliding parts 51 being displaced along the support leg 42 in the displacement direction t. A spacing dimension e′ results between the abutment surfaces 44 or 54 and 46 of the second insertion leg 43, which is smaller than the corresponding spacing dimension e in the basic position for receiving a larger-diameter workpiece 39 according to FIG. 19, thereby permitting reception of a workpiece 39 of smaller diameter than in FIG. 20. FIG. 21 shows a further displacement of the sliding parts 51 for receiving a workpiece 39 of still smaller diameter compared with FIG. 19. The spacing dimension e″ is accordingly further reduced due to the corresponding displacement of the sliding parts 51, in which displacement position a detent of the connecting bracket 61 in the region of the second detent recess 66 with the detent portion 67 is achievable.

FIGS. 31 to 41 show a further embodiment of a cutting tool 1 with an adjustable receiving part 6, for example adaptable to the diameter of the workpiece 39.

As in the embodiment described above, here too a sliding part 51 is mounted on each side of the second insertion slot 40, preferably symmetrically with respect to the cutting plane E, on a fixed part 50 of the receiving part 6 substantially reproducing the U-shaped receiving contour 49, each sliding part 51 being guided linearly in a window-like cutout 56 in the region of the support leg 42 of the fixed part 50.

Each sliding part 51 forms, in accordance with the embodiment shown in FIGS. 13 to 27, an insertion sub-leg 52 and an abutment sub-leg 53, wherein, by virtue of the linear displaceability of the sliding parts 51 coupled to one another, an adaptation of the spacing dimension e between the insertion sub-leg 52 substantially forming the first insertion leg 41 and the second insertion leg 43 of the receiving part 6 rigid relative to the sliding part 51, or the adjacent shoulder 74 of the tool body 7 in the swung-in holding position of the receiving part 6, in the case of a receiving part 6 formed with only one insertion leg, is possible, for example, to the diameter of the workpiece 39.

Each sliding part 51 may, as explained with reference to the embodiment described above, be displaceably mounted on the fixed part 50 via a plate-shaped insert part 59. The insert part 59 passes through a slot opening 58 formed in a web 57 formed on the underside of the abutment sub-leg 53 and under-engages a shoulder 60 of the fixed part 50, in which fixed part 50 the insert part 59 is guided in a slot recess 80 extending in the displacement direction t.

The underside of each insert part 59 facing away from the receiving space 37 is provided with a toothing 75. The foot- and head-side tooth lines of this preferably straight toothing 75 are oriented perpendicular to the cutting plane E and transverse to the displacement direction t of the insertion sub-leg 52.

The toothing is designed for positive engagement with a correspondingly formed counter-toothing 76 which is formed on a component of the cutting tool 1 rigid relative to the sliding part 51. As a result of such positive engagement, an adopted displacement position of the sliding part 51 can be fixed.

According to the embodiment shown, such a counter-toothing 76 is preferably formed on an edge of the stationary cutting part 4 of the tool body 7 facing the receiving part 6 in the swung-in holding position. Accordingly, in this embodiment, the locking position of the sliding part 51 can only be assumed after the receiving part 6 has been swung into this holding position, and thus only in the position in which a cutting operation is carried out.

Before completion of the swinging-in movement, in this embodiment no positional fixing of the sliding part 51 is preferably yet provided.

In a user-friendly manner, each sliding part 51 is biased into a contact position with a workpiece 39 to be received in the receiving part 6. As a result, in particular each insertion sub-leg 52 of the sliding parts 51 is pressed into a contact position with the workpiece 39.

Accordingly, the sliding parts 51 are biased in the direction of a basic position in which the receiving part 6, viewed in the displacement direction t of the insertion sub-leg 52, has a minimum possible extent e″.

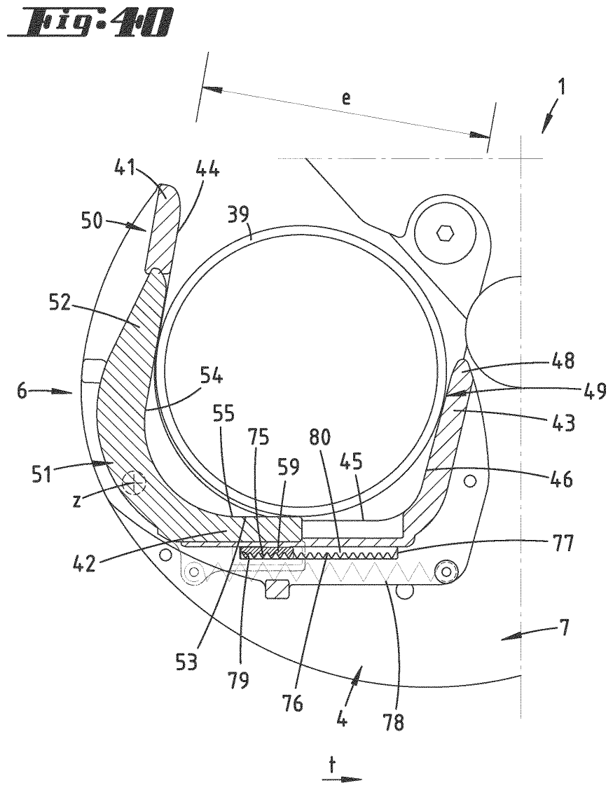

This basic position is preferably stop-limited. For example, this may be achieved by the insert part 59 striking against a stop shoulder 77 formed at the end, in the displacement direction t, of the slot recess 80 (cf. FIG. 41).

The above-described biasing of the sliding parts 51 toward the basic position is preferably achieved by arranging a spring 78, in particular a tension spring. For this purpose, one end of the spring 78 engages the associated sliding part 51. The other spring end is anchored to a section of the fixed part 50 of the receiving part 6 that is rigid relative to the sliding part 51. Thus, the spring loading on each sliding part 51 is present in every pivot position of the receiving part 6.

A workpiece 39 to be cut is inserted, in the swung-out receiving position, into the receiving space 37 of the receiving part 6, optionally with displacement of the insertion sub-legs 52 of the sliding parts 51 out of the basic position against the return force of the springs 78, depending on the cross-sectional extent of the workpiece 39.

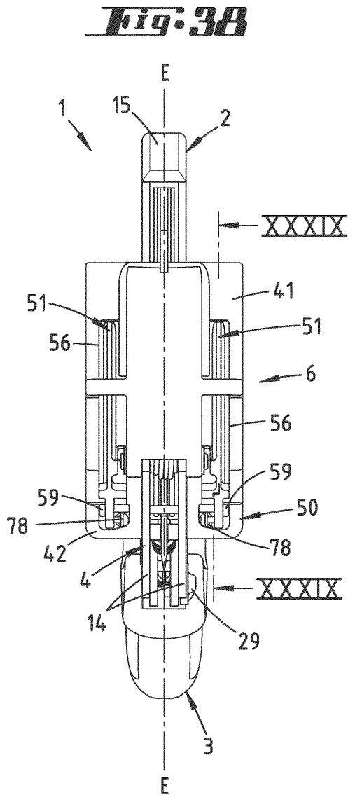

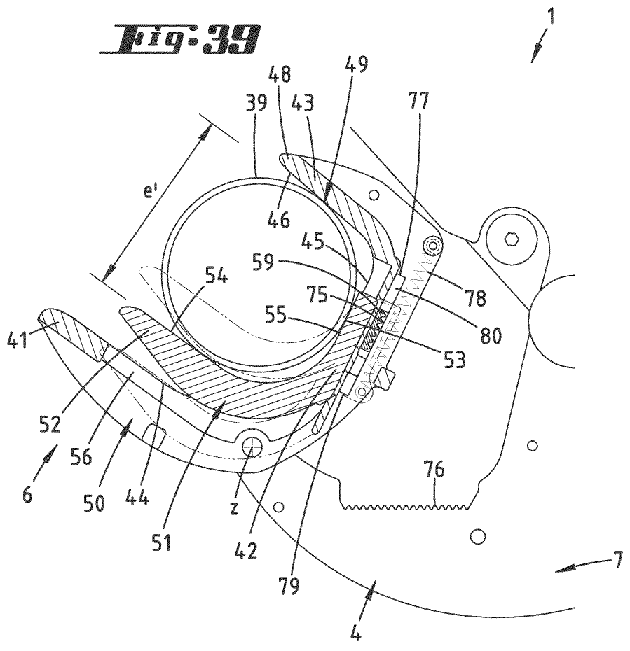

FIGS. 39, 40, and 41 show the reception of a workpiece 39 with different cross-sectional dimensions (diameters) and the insertion sub-leg positions that are established in each case. In accordance with the embodiment described above, spacing dimensions e (for the maximum spacing as shown in FIG. 40), e′ (for an exemplary intermediate spacing as shown in FIG. 39), and e″ (for the minimum spacing as shown in FIG. 41) are obtained between the abutment surface portion 54 of the insertion sub-leg 52 and the abutment surface of the second insertion leg 43, which is rigid in relation thereto.

Preferably, displacement of each sliding part 51 is also stop-limited in the direction toward the greatest spacing from the second insertion leg 43, for example, as shown in FIG. 40, by a stop shoulder 79 formed in the region of the slot recess 80 opposite the stop shoulder 77 in the displacement direction t.

The workpiece 39, which is clamped by spring force between the insertion sub-leg 52 and the second insertion leg 43 and supported on the support leg 42, is swung together with the receiving part 6 into the holding position, self-acting positive locking of the displacement position of the insertion sub-legs 52 being achieved upon reaching the holding position as a result of positive engagement of the receiving-part toothing 75 with the counter-toothing 76 of the tool body 7. The forces acting on the insertion sub-legs 52 during a cutting operation via the blade 16 are transmitted into the tool body 7 through the positive engagement between the toothing 75 and the counter-toothing 76.

Building on the fourth embodiment described above, FIGS. 42 to 52 show a configuration in which, with essentially the same construction, the receiving part 6 is not pivotally articulated at the free end 33 of the associated cutting part 4 but is instead arranged to be linearly displaceable.

In this case, for example and preferably, a displacement direction s of the receiving part 6 as a whole is obtained in the direction of a longitudinal extent L of the cutting part 4. Furthermore, preferably, this displacement direction s is aligned with the displacement direction t of the sliding part 51 relative to the fixed part 50.

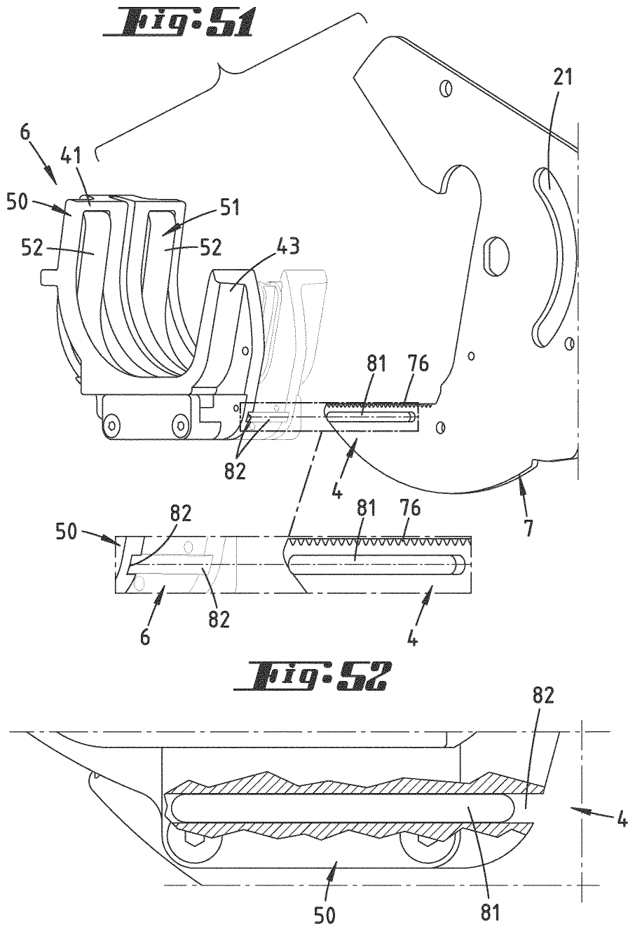

For this purpose, for example as shown, rib-like linear guides 81 provided laterally on the cutting part 4 can engage in correspondingly formed longitudinal grooves 82 in the fixed part 50 (see FIGS. 51 and 52), preferably with stop limitation provided in both displacement directions s of the linear displacement.

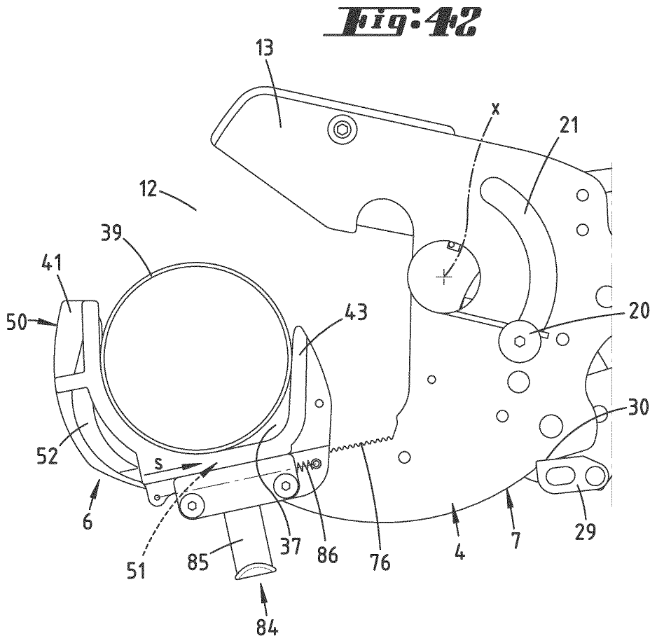

Thus, for loading with a workpiece 39, the receiving part 6 can be brought into the receiving position by displacement into a forward position according to FIG. 42. To perform the cutting operation, the workpiece 39 is also pushed back together with the receiving part 6 into the stop-limited holding position according to FIG. 43. By means of the sliding parts 51, as in the fourth embodiment, in the fifth embodiment an adaptation of the receiving-part opening area to the cross-sectional area or to the diameter of the workpiece 39 is likewise made possible.

The holding position assumed by the sliding parts 51 of the receiving part 6 as a result of spring loading, for example by a tension spring 86 according to FIG. 42, is also secured by detent in this embodiment similarly to the embodiment described above. In this case, the toothings 75 provided on the undersides of the insert parts 59 cooperate in a detent manner with a counter-toothing 76 of the cutting part 4, the detent possibly already being achieved in the receiving position or alternatively, as shown, only during the displacement of the receiving part 6 back toward the holding position.

For this purpose, with reference to a side view for example according to FIG. 51, in comparison with the previously described version the counter-toothing 76, like the edge of the cutting part 4 facing the receiving space 37, is formed to run rectilinearly starting from the shoulder 74 of the tool body 7 and is substantially oriented in the displacement direction s of the receiving part 6.

During displacement of the receiving part 6 toward the holding position, ratchet-like overrunning of the toothing 75 and counter-toothing 76 can occur. This can be achieved by a corresponding angular setting of the cooperating teeth in the displacement return direction, whereas in the opposite direction, that is toward the receiving position advanced relative to the receiving space 37, such ratchet-like overrunning can be prevented by the selected orientation of the tooth flanks.

The ratchet-like overrunning in the one displacement direction is additionally achieved by providing one of the toothing components with compliance for yieldable displacement.

As a result of the non-overrunnable tooth engagement in the direction toward the receiving position, the position of the carriage is also secured during the cutting operation.

The toothing 75 can, as in the fourth embodiment, be formed on an insert part 59 held in the respective sliding part 51. This insert part 59 is received in the web 57 of the associated sliding part 51 so as to be displaceable in a direction perpendicular to the displacement direction s. The insert part 59 is spring-loaded in the direction toward the positive-locking engagement with the counter-toothing 76. For this purpose, a spring 83, for example in the form of a leaf spring, may be provided, which is supported on the underside of the abutment sub-leg 53 of the sliding part 51 assigned to the insert part 59 and acts on the insert part 59 (see FIGS. 45 to 47).

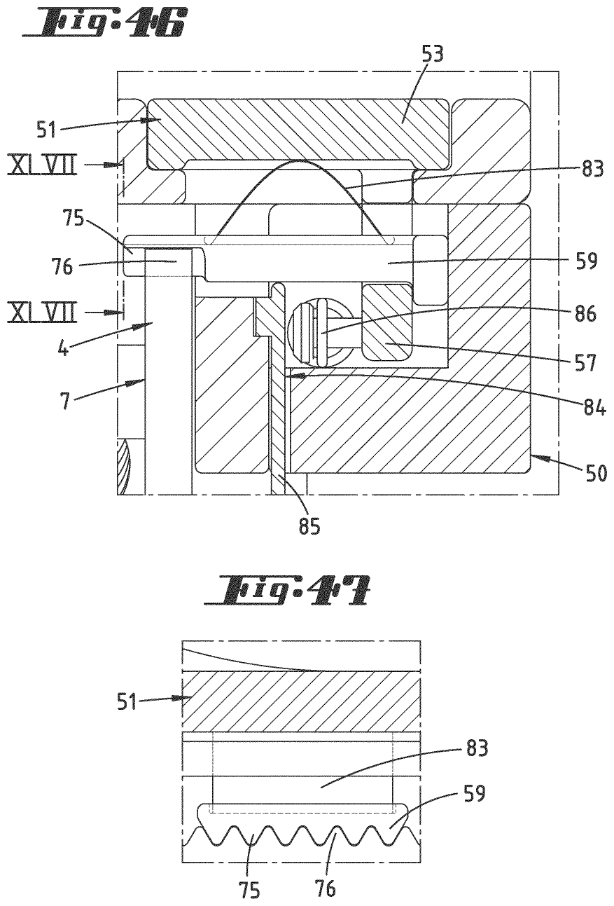

In order to return the receiving part 6 and, respectively, each sliding part 51 to their advanced starting position, the positive-locking engagement between the toothing 75 and the counter-toothing 76 must be released. For the purpose of this release to be effected by the user, an actuating handle 84 can be provided, which is mounted in the fixed part 50 of the receiving part 6 to be movable substantially perpendicular to the displacement direction s. The actuating handle 84 can have two actuating legs 85, by the free ends of which the insert parts 59 can be lifted against the restoring force of the springs 83 to act on the insert parts 59. As a result of such action, release of the positive-locking engagement can be achieved (see FIGS. 48 to 50).

Moreover, the receiving part 6 of the fourth or fifth embodiment can also be mounted fixed on the cutting part 4, so that in this respect there is no relative movability of the receiving part 6, in particular of the fixed part 50, relative to the cutting part 4. In this case, a workpiece 39 can, for example, be pushed laterally into the receiving space. Adaptation of the receiving-part opening area can be achieved by displacement of the sliding parts 51, the adopted contact position of the sliding parts 51 on the workpiece 39 being detent-secured as described above by cooperation of the receiving-part toothings 75 with the counter-toothings 76 on the cutting part side. Release of the tooth engagement for returning the sliding parts 51 can be carried out manually in accordance with the fifth embodiment (resiliently liftable counter-toothing with actuating handle).

The foregoing explanations serve to illustrate the inventions encompassed by the application as a whole, which each further develop the prior art independently by at least the following combinations of features, wherein two, several, or all of these combinations of features may also be combined with one another, namely:

A cutting tool, characterized in that at the free end 33 of one of the cutting parts 4 an angular receiving part 6 is articulated, which is pivotable between a swung-out receiving position and a swung-in holding position for holding a workpiece 39 during a cutting operation.

A cutting tool, characterized in that at a free end 33 of one of the cutting parts 4, 5 a receiving part 6 is attached and that the receiving part 6 is detent-adjustable for changing a receiving space 37 which is bounded by the receiving part 6 itself or by the receiving part 6 in cooperation with one of the cutting parts 4, 5.

A cutting tool, characterized in that at the free end 33 of one of the cutting parts 4 an angular receiving part 6 is attached which is displaceable between a forward receiving position and a retracted holding position for holding a workpiece 39 during a cutting operation.

A cutting tool, characterized in that the cutting tool 1 is hand-operable and has a first and a second handle part 2, 3.

A cutting tool, characterized in that a first cutting part 4 is formed as a stationary cutting part 4 and the joint 10 is arranged on the first cutting part 4.

A cutting tool, characterized in that both handle parts 2, 3 are attached to the stationary cutting part 4 and the second cutting part 5 is pivotable via a ratchet drive 8.

A cutting tool, characterized in that the receiving part 6 is articulated at the free end 33 of the stationary cutting part 4.

A cutting tool, characterized in that the first cutting part 4 has a first insertion slot 31 into which the second cutting part 5 enters during a cutting operation.

A cutting tool, characterized in that the receiving part 6 has a second insertion slot 40 into which the second cutting part 5 enters during a cutting operation.

A cutting tool, characterized in that, viewed perpendicular to the cutting plane E, the receiving part 6 has a U-shaped configuration.

A cutting tool, characterized in that the receiving part 6 has a receiving contour 49 delimiting an opening area of the U-shaped configuration, which receiving contour 49 is not penetrated by an outermost edge of the first cutting part 4 regardless of the pivot position.

A cutting tool, characterized in that the receiving part 6 has an insertion leg 41 and a support leg 42 extending approximately at right angles thereto.

A cutting tool, characterized in that, in the holding position of the receiving part 6, the insertion leg 41 substantially closes the cutting mouth M before the start of a cutting operation.

A cutting tool, characterized in that the receiving part 6 has two insertion legs, a first and a second insertion leg 41, 43, which together with the support leg 42 produce the U-shaped configuration of the receiving part 6.

A cutting tool, characterized in that the first insertion leg 41 is displaceable to change the size of the receiving-part opening area.

A cutting tool, characterized in that the first insertion leg 41 is displaceable along the support leg 42.

A cutting tool, characterized in that the first insertion leg 41 is held in different displacement positions by detent.

A cutting tool, characterized in that a detent between the first insertion leg 41 and the support leg 42 fixed relative thereto is achievable and that this detent is present both in the receiving position and in the holding position.

A cutting tool, characterized in that a detent between the first insertion leg 41 and the cutting part 4 fixed relative thereto is achievable and that this detent is present only in the holding position.

A cutting tool, characterized in that the stationary cutting part 4 has a counter-toothing 76 for detent cooperation with a toothing 75 of the first insertion leg 41.

A cutting tool, characterized in that the toothing 75 is formed on an insert part 59 for linearly displaceable mounting of the first insertion leg 41 on the support leg 42.

A cutting tool, characterized in that the first insertion leg 41 is biased by a spring 78 into a basic position in which the receiving part 6, viewed in a displacement direction t of the first insertion leg 41, has a minimum extent e″ of the U-shaped configuration.

A cutting tool, characterized in that, in the holding position, a force of the second cutting part 5 acting on the workpiece 39 loads the receiving part 6 into the swung-in or the retracted position.

All disclosed features are essential to the invention (individually and also in combination with one another). The disclosure content of the associated or appended priority documents (a copy of the prior application) is hereby incorporated in its entirety into the disclosure of the present application, also for the purpose of incorporating features of those documents into claims of the present application. The dependent claims characterize, even without the features of a claim referred to, independent inventive further developments of the prior art with their features, in particular in order to file divisional applications based on these claims. The invention disclosed in each claim may additionally have one or more of the features mentioned in the foregoing description, in particular those provided with reference numerals and or listed in the list of reference numerals. The invention also relates to embodiments in which individual features mentioned in the foregoing description are not implemented, in particular insofar as they are evidently dispensable for the respective intended use or can be replaced by other technically equivalent means.

List of Reference Signs

| | |
|---|---|
| 1 | cutting tool |
| 2 | first handle part |
| 3 | second handle part |
| 4 | first cutting part |
| 5 | second cutting part |
| 6 | receiving part |
| 7 | tool body |
| 8 | ratchet drive |
| 9 | pivot pin |
| 10 | joint |
| 11 | grip sleeve |
| 12 | cutting-receiving opening |
| 13 | leg |
| 14 | part |
| 15 | cap |
| 16 | blade |
| 17 | cutting edge |
| 18 | ratchet section |
| 19 | toothing |
| 20 | guide pin |
| 21 | guide groove |
| 22 | feed lever |
| 23 | feed finger |
| 24 | pawl lever |
| 25 | pawl finger |
| 26 | leg spring |
| 27 | return spring |
| 28 | handle |
| 29 | locking lever |
| 30 | locking edge |
| 31 | first insertion slot |
| 32 | free end |
| 33 | free end |
| 34 | U-leg |
| 35 | U-leg |
| 36 | U-web |
| 37 | receiving space |
| 38 | receiving opening |
| 39 | workpiece (to be cut) |
| 40 | second insertion slot |
| 41 | first insertion leg |
| 42 | support leg |
| 43 | second insertion leg |
| 44 | abutment surface |
| 45 | abutment surface |
| 46 | abutment surface |
| 47 | free end |
| 48 | free end |
| 49 | receiving contour |
| 50 | fixed part |
| 51 | sliding part |
| 52 | insertion sub-leg |
| 53 | abutment sub-leg |
| 54 | abutment surface portion |
| 55 | abutment surface portion |
| 56 | cutout |
| 57 | web |
| 58 | slot opening |
| 59 | insert part |
| 60 | shoulder |
| 61 | connecting bracket |
| 62 | U-leg |
| 63 | U-web |
| 64 | web |
| 65 | pin |
| 66 | detent recess |
| 67 | detent portion |
| 68 | surface |
| 69 | counter-surface |
| 70 | stop shoulder |
| 71 | surface |
| 72 | receiving-boundary surface |
| 73 | edge surface |
| 74 | shoulder |
| 75 | toothing |
| 76 | counter-toothing |
| 77 | stop shoulder |
| 78 | spring |
| 79 | stop shoulder |
| 80 | slot recess |
| 81 | linear guide |
| 82 | longitudinal groove |
| 83 | spring |
| 84 | actuating handle |
| 85 | actuating legs |
| 86 | tension spring |
| a | length |
| b | length |
| c | length |
| d | length |
| e | spacing dimension |
| e′ | spacing dimension |
| e″ | spacing dimension |
| r | pivot direction |
| s | displacement direction |
| t | displacement direction |
| u | pivot axis |
| x | pivot axis |
| y | pivot axis |
| z | pivot axis |
| E | cutting plane |
| M | cutting mouth |
| O | opening plane |
| P | force |
| R1 | radius |
| R2 | radius |
| S1 | intersection point |
| S2 | intersection point |
| α | angle |
| β | angle |

1. A cutting tool (1) having two cutting parts (4, 5) comprising a first cutting part (4) and a second cutting part (5), the cutting parts (4, 5) being connected to one another by a joint (10) for respective movement along a cutting plane (E), the cutting parts (4, 5) further bounding, in an open state of the cutting parts (4, 5), a cutting mouth (M), and each one of the cutting parts having free ends (32, 33) remote from the joint (10) and ends facing the joint (10), wherein an angular receiving part (6) is articulated at the free end (33) of one of the cutting parts (4), the receiving part (6) being pivotable between a swung-out receiving position and a swung-in holding position for holding a workpiece to be cut (39) during a cutting operation, wherein, viewed perpendicular to the cutting plane (E), a receiving contour (49) of the receiving part (6) has an overall substantially U-shaped configuration with two U-legs comprising a first U-leg (34) and a second U-leg (35), and a U-web (36) connecting the U-legs (34, 35), the U-legs (34, 35) and the U-web (36) having abutment surfaces (44, 45, 46) bounding a receiving space (37) with a receiving opening (38), wherein the receiving opening (38) in the swung-out receiving position is oriented substantially in the same direction as the cutting-receiving opening (12) of the cutting mouth (M), such that a workpiece (39) to be introduced into the receiving part (6) passes through both the cutting-receiving opening (12) and the receiving opening (38), or wherein the receiving part (6), in a region of the resulting receiving contour (49), has a substantially L-shaped configuration with one of the U-legs (34) forming an insertion leg (41) and the U-web (36) forming a support leg (42), and wherein articulation of the receiving part (6) to the stationary cutting part (4) is provided in a region of a transition between the first U-leg (34) and the U-web (36).

2. A cutting tool having two cutting parts (4, 5) comprising a first cutting part (4) and a second cutting part (5), the cutting parts (4, 5) being connected to one another by a joint (10) for respective movement along a cutting plane (E), the cutting parts (4, 5) further bounding, in an open state of the cutting parts (4, 5), a cutting mouth (M), and each having free ends (32, 33) remote from the joint (10) and ends facing the joint (10), wherein a receiving part (6) is mounted at the free end (33) of one of the cutting parts (4, 5) and the receiving part (6) is detent-adjustable to vary a receiving space (37) which is bounded by the receiving part (6) itself or by the receiving part (6) in cooperation with one of the cutting parts (4, 5), wherein the receiving part (6) has two insertion legs comprising a first insertion leg (41) and a second insertion leg (43), which together with a support leg (42) provide a U-shaped configuration of the receiving part (6), and wherein the first insertion leg (41) is displaceable along the support leg (42) to change a size of a receiving-part opening area.

3. A cutting tool having two cutting parts (4, 5) comprising a first cutting part (4) and a second cutting part (5), the cutting parts (4, 5) being connected to one another by a joint (10) for respective movement along a cutting plane (E), the cutting parts (4, 5) further bounding, in an open state of the cutting parts (4, 5), a cutting mouth (M), and each one of the cutting parts having free ends (32, 33) remote from the joint (10) and ends facing the joint (10), wherein an angular receiving part (6) is mounted at the free end (33) of one of the cutting parts (4), the receiving part (6) being displaceable between a forward receiving position and a retracted holding position for holding a workpiece to be cut (39) during a cutting operation, wherein the receiving part (6) has a U-shaped configuration or an L-shaped configuration with a U-leg (34) forming an insertion leg (41) and a U-web (36) forming a support leg (42), and wherein the insertion leg (41) is displaceable along the support leg (42).

4. The cutting tool according to claim 1, wherein the cutting tool (1) is hand-operated and has a first handle part (2) and a second handle part (3).

5. The cutting tool according to claim 1, wherein the first cutting part (4) is formed as a stationary cutting part (4) and the joint (10) is arranged on the first cutting part (4).

6. The cutting tool according to claim 5, wherein both handle parts (2, 3) are mounted on the stationary cutting part (4) and the second cutting part (5) is pivotable via a ratchet drive (8).

7. The cutting tool according to claim 5, wherein the receiving part (6) is articulated at the free end (33) of the stationary cutting part (4).

8. The cutting tool according to claim 1, wherein the first cutting part (4) has a first insertion slot (31) into which the second cutting part (5) enters during a cutting operation.

9. The cutting tool according to claim 1, wherein the receiving part (6) has a second insertion slot (40) into which the second cutting part (5) enters during a cutting operation.

10. The cutting tool according to claim 1, wherein, viewed perpendicular to the cutting plane (E), the receiving part (6) has a U-shaped configuration.

11. The cutting tool according to claim 10, wherein the receiving part (6) has a receiving contour (49) which bounds an opening area of the U-shaped configuration, wherein the receiving contour (49), irrespective of the pivot position, is not penetrated by an outermost edge of the first cutting part (4).

12. (canceled)

13. The cutting tool according to claim 1, wherein, in the holding position of the receiving part (6), the insertion leg (41) substantially closes the cutting mouth (M) prior to the start of a cutting operation.

14-18. (canceled)

19. The cutting tool according to claim 2, wherein the first insertion leg (41) is held by a detent in different displacement positions.

20. The cutting tool according to claim 2, wherein a detent between the first insertion leg (41) and the support leg (42) fixed relative thereto is achievable and wherein this detent is present both in the receiving position and in the holding position.

21. The cutting tool according to claim 2, wherein a detent between the first insertion leg (41) and the cutting part (4) fixed relative thereto is achievable, and wherein this detent is present only in the holding position.

22. The cutting tool according to claim 21, wherein the stationary cutting part (4) has a counter-toothing (76) for detent cooperation with a toothing (75) of the first insertion leg (41).

23. The cutting tool according to claim 22, wherein the toothing (75) is formed on an insert part (59) for linearly displaceable mounting of the first insertion leg (41) on the support leg (42).

24. The cutting tool according to claim 13, wherein the first insertion leg (41) is biased by a spring (78) into a basic position in which the receiving part (6), viewed in a displacement direction (t) of the first insertion leg (41), has a minimum extent (e″) of the U-shaped configuration.

25. The cutting tool according to claim 1, wherein, in the holding position, a force of the second cutting part (5) acting on the workpiece (39) loads the receiving part (6) into the swung-in or into the retracted position.
